(19) United States
(12) Patent Application Publication
(10) Pub. No.: US 2011/0246763 A1
(43) Pub. Date: Oct. 6, 2011

(54) Parallel method, machine, and computer program product for data transmission and reception over a network

(76) Inventor: Jason Wayne Karnes, Chesterfield, VA (US)

(21) Appl. No.: 12/798,418

(22) Filed: Apr. 3, 2010

(51) Int. Cl. G06F 15/16; H04L 9/00; G06F 12/00

(52) U.S. Cl. 713/150; 709/203; 711/154; 711/E12.001

(57) ABSTRACT

A method, machine, and computer program product for high speed data transmission over networks by multiple data connections transmitting data in parallel having read from a data source sequentially a fixed number of blocks equal to the number of data connections in use to transmit the data. A method, machine, and computer program product for high speed data receipt from networks by multiple data connections receiving data in parallel and writing to a data target sequentially a fixed number of blocks equal to the number of data connections in use to receive the data. The purpose is to provide high speed data transfers over a network while maintaining: the same sequential order of data which was read from the data source and subsequently written to the data target, a stable and uniform transmission speed, and limited data loss in the event of a network failure.

### FIELD

The present inventive subject matter relates to data transmission and reception using a data communication network and more particularly to: a parallel transmission and reception method, machine, and computer program product that additionally preserves the sequential order of data as read by a sender, transmitted over a network, received from the network by a receiver, and written by the receiver.

### BACKGROUND

### Prior Art

The increasing volume of data processed and created by business and private users coupled with increases in network bandwidth capacities of the global Internet and private network circuits are driving a demand for large volumes of structured data to be transferred or streamed between systems that are separated by great distance.

Geographical distance and the variability of congestion within a network impose non-uniform latency for data traversing a network. Connection oriented protocols, such as the Transmission Control Protocol (TCPv4 & TCPv6) suffer effective data transfer rate reductions as the Round Trip Time (RTT) increases due to latency. One cause for the reduction in the performance of TCP and other similar connection-oriented protocols is the delay in receiving positive acknowledgement messages from the receiver by the sender which causes the sender to pause before additional data can be sent. Some of these issues may be overcome by adjusting tuning parameters of the TCP/IP network stack on the sender and receiver systems, however, these changes must be implemented by advanced technical users with System Administration privileges and the changes affect all transfers on these systems. Another cause for the reduction in performance of TCP and other similar connection-oriented protocols is the loss of packets due to data corruption and packet loss due to network congestion which must be retransmitted. Adjustment of tuning parameters for the TCP/IP network stack can exacerbate this problem as the amount of data for each required retransmission increases which further delays data that could have been transmitted during the time taken for the retransmission of corrupted or lost packets.

Conventional data transfer systems utilizing TCP and designed at a time when network bandwidth rates were much lower than that available today did not suffer pronounced performance degradations as the maximum network bandwidth available was below the limitations imposed by high RTTs. SCP (Secure Copy, a component of OpenSSH) and FTP (File Transfer Protocol) are traditional file transfer applications which utilize TCP and suffer performance degradation on high-latency networks.

### SUMMARY

A method, machine, and computer program product are provided for transmitting data over a network. This may include sequentially reading a data source on a sender system and transmitting multiple data blocks in parallel across a network to a receiver.

A method, machine, and computer program product are provided for receiving data over a network. This may include: receiving in parallel multiple data blocks from a network and writing data blocks sequentially to a data target.

Embodiments may use reliable data delivery protocols e.g. TCPv4 and TCPv6.

Embodiments may use data transformation modules enabling a sender system to transform data (e.g. encrypt, compress, etc.) after reading data from a data source.

Embodiments may use data transformation modules enabling a receiver system to transform data (e.g. decrypt, decompress, etc.) before writing data to a data target.

Other features and uses of the embodiments will become apparent from the following description and associated drawings.

### DRAWINGS—Figures

In the following detailed description and claims, reference is made to the accompanying drawings which illustrate example embodiments in which the inventive subject matter may be practiced. The foregoing and following written description and accompanying drawings forming a part of the disclosure focus on disclosing example embodiments of the inventive subject matter by way of illustration and example only. The foregoing and following written description and accompanying drawings are therefore not to be taken in a limited sense and the scope of the inventive subject matter is defined by the appended claims and their legal equivalents. Example embodiments are described in sufficient detail to enable those skilled in the art to practice them. It is understood that other embodiments may be utilized and that structural, syntactic, semantic, logical, and electrical changes may be made without departing from the scope of the inventive subject matter. Embodiments of the present inventive subject matter may be realized using hardware, software, firmware, and/or any combination thereof. It is understood that embodiments may be comprised of components which may be realized using hardware, software, firmware, and/or any combination thereof.

FIG. 1 is a flowchart of a sender process according to an example embodiment.

FIG. 2 is a flowchart of a sender command channel reader management process according to an example embodiment.

FIG. 3 is a flowchart of a sender data reader process according to an example embodiment.

FIG. 4 is a flowchart of a sender network communications process according to an example embodiment.

FIG. 5 is a flowchart of a receiver process according to an example embodiment.

FIG. 6 is a flowchart of a receiver command channel reader management process according to an example embodiment

FIG. 7 is a flowchart of a receiver network communications process according to an example embodiment.

FIG. 8 is a flowchart of a receiver data writer process according to an example embodiment.

FIG. 9 is a block diagram of a command channel preamble data structure according to an example embodiment.

FIG. 10 is a block diagram of a data channel preamble data structure according to an example embodiment.

FIG. 11 is a block diagram of a data channel block preamble data structure according to an example embodiment.

FIG. 12 is a block diagram of the hardware components of a computer system where a sender system and receiver system may make use of the components according to an example embodiment.

FIG. 13 is a flowchart of a sender system transmitting data over a network to a receiver system, and a receiver system receiving data from a network from a sender system according to an example embodiment.

FIG. 14 is a flowchart of a sender system data transformation module and associated data transformation module methods according to an example embodiment.

FIG. 15 is a flowchart of a receiver system data transformation module and associated data transformation module methods according to an example embodiment.

### DETAILED DESCRIPTION

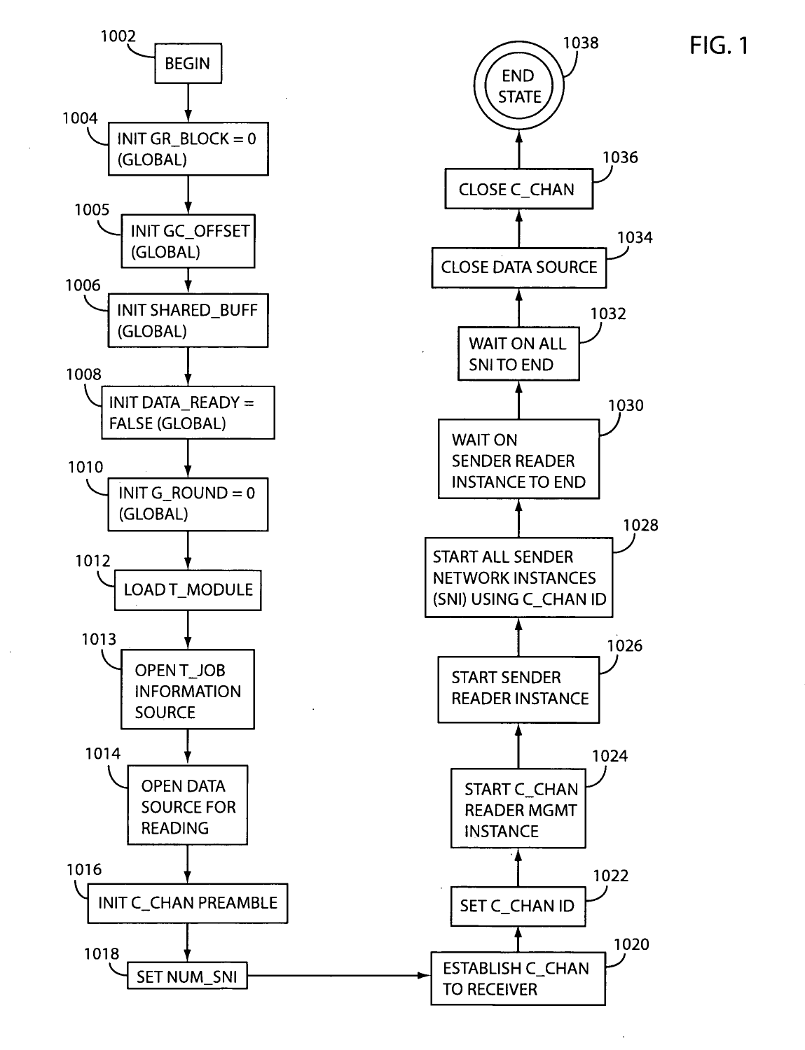

FIG. 1

FIG. 1 is a flowchart illustrating a process consisting of a set of operations for transmitting data from a sender system (13002) to a receiver system (13006) over a network (13004) in accordance with an example embodiment. Additional embodiments may be realized by changing the order of operations within the process or by splitting the set of operations and/or additional operations across multiple processes.

The process 1000 begins at operation 1002 which configures the sender system processor (12002) for the remaining operations within the process. Once the sender system hardware is configured for processing further instructions, the 1000 process may proceed to allocate and initialize shared data structures for usage between the 1000 process and other processes within the sender system.

GR_BLOCK (1004) is a shared transmission round block counter used by processes 1000, 3000, and 4000 to track the number of blocks processed in a transmission round.

GC_OFFSET (1005) is a shared offset counter used by processes 1000 and 4000 to store the offset address of the data source to be used if the data transmission is restarted.

SHARED_BUFF (1006) is a shared data block storage structure used to temporarily store blocks for each transmission round and is used by processes 1000, 3000, and 4000.

DATA_READY (1008) is a shared tri-state status indicator which may have values: true, false, and last_round and is used by processes 1000, 3000, and 4000.

G_ROUND (1010) is a shared transmission round counter which tracks the total number of transmission rounds processed and is used by processes 1000, 3000, and 4000.

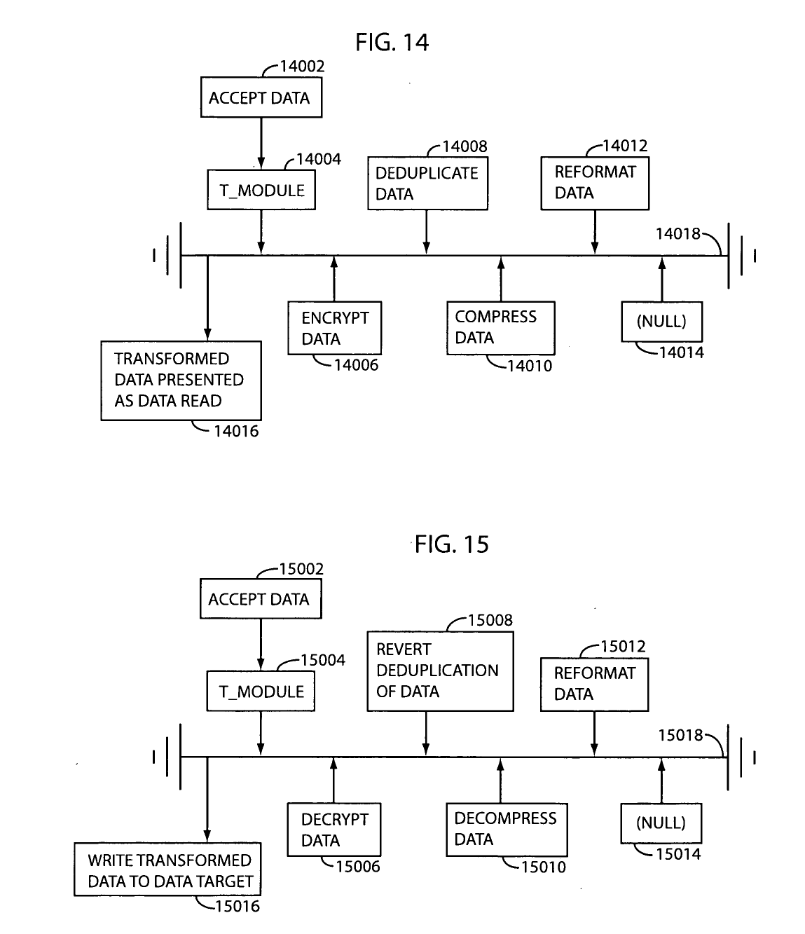

Once initialization of the shared data structures is complete, the 1000 process may proceed to 1012 to optionally load and initialize an external data transformation module depicted in the figures as T_MODULE (Refer to FIG. 14).

Some embodiments may use the data transformation module that may implement one or more of the following data transformation module methods: data deduplication methods (14008), encryption methods (14006), compression methods (14010), and/or data reformat methods (14012).

The 1000 process may then proceed to (1013) to open the transmission job information source which may be one of: a network socket, a named pipe, a regular command pipe reading from standard input, a file, or a data terminal directed by a human operator. The transmission job information source provides to process 1000: the data source, the data target, the number of parallel streams to use for the transmission also known as the NUM_SNI or number of data channels value, the default reader block size used by process 3000, and the data source reader starting offset.

The 1000 process may then proceed to (1014) to open the data source which may be one of: a network socket, a named pipe, a regular command pipe reading from standard input, a file, a directory containing files and/or additional directories, a block device, a character device, or a data terminal directed by a human operator and seek to the data source reader starting offset as specified by the transmission job information source (1013).

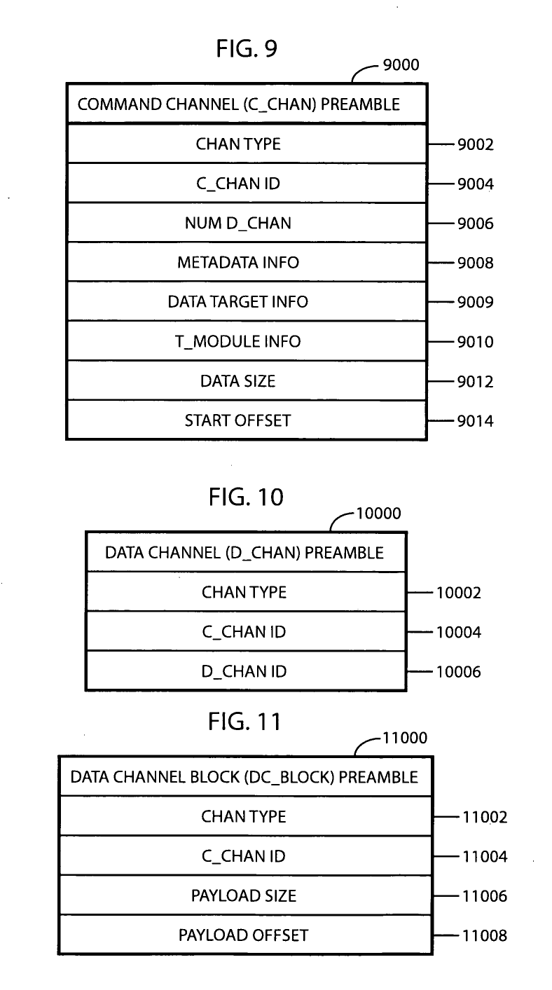

The 1000 process may then proceed to 1016 to initialize a Command Channel (C_CHAN) preamble data structure (Refer to FIG. 9). The process 1000 sets the number of parallel streams (1018) hence forth referred to as the Sender Network Instances (NUM_SNI) (1018) to be used for transmitting the data from the sender system (13002) to the receiver system (13006). The number of blocks in a transmission round is equal to the number of sender network instances. Additionally, the SHARED_BUFF (1006) may store a number of data blocks equal to NUM_SNI (1018).

The 1000 process may establish a command channel (C_CHAN) 1020 via a network (13004) from the sender system (13002) to the receiver system (13006) for transmitting commands to and receiving commands from the receiver system (13006). To establish the command channel, the 1000 process may transmit a command channel preamble (9000) via a network (13004) to the receiver system (13006).

The 1000 process sets the command channel preamble channel type (9002) (CHAN TYPE) to a value representative of a command channel.

The 1000 process sets the command channel preamble command channel identification (9004) (C_CHAN ID) to a default value.

The 1000 process sets the command channel preamble number of data channels (9006) (NUM D_CHAN) to the value of NUM_SNI (1018) as that reflects the number of sender network instances (data channels) to be used for transmitting data in parallel.

The 1000 process optionally sets the command channel preamble metadata information block (9008) (METADATA) which may be used to store metadata information about the source data. The metadata information block may be set to a default value representing that the data being transmitted is streaming data and therefore does not require metadata external to the data stream to be transported.

The 1000 process optionally sets the command channel preamble data target information block (9009) which may be used to store information about the data target to be used by the receiver system (13006).

The 1000 process optionally sets the command channel preamble to contain transformation module configuration information 9010 (T_MODULE INFO) identifying a transformation module method or set of transformation module methods and associated configuration information for proper transformation of data on the receiver system (13006).

The 1000 process optionally sets the command channel preamble to contain a data size (9012) to indicate the total size of data being transmitted from a sender system to a receiver system. Embodiments transmitting streaming data or where the data size is unknown may not include a data size value.

The 1000 process optionally sets the command channel preamble to contain a start offset (9014) to indicate the starting data reader position offset from the data source being transmitted.

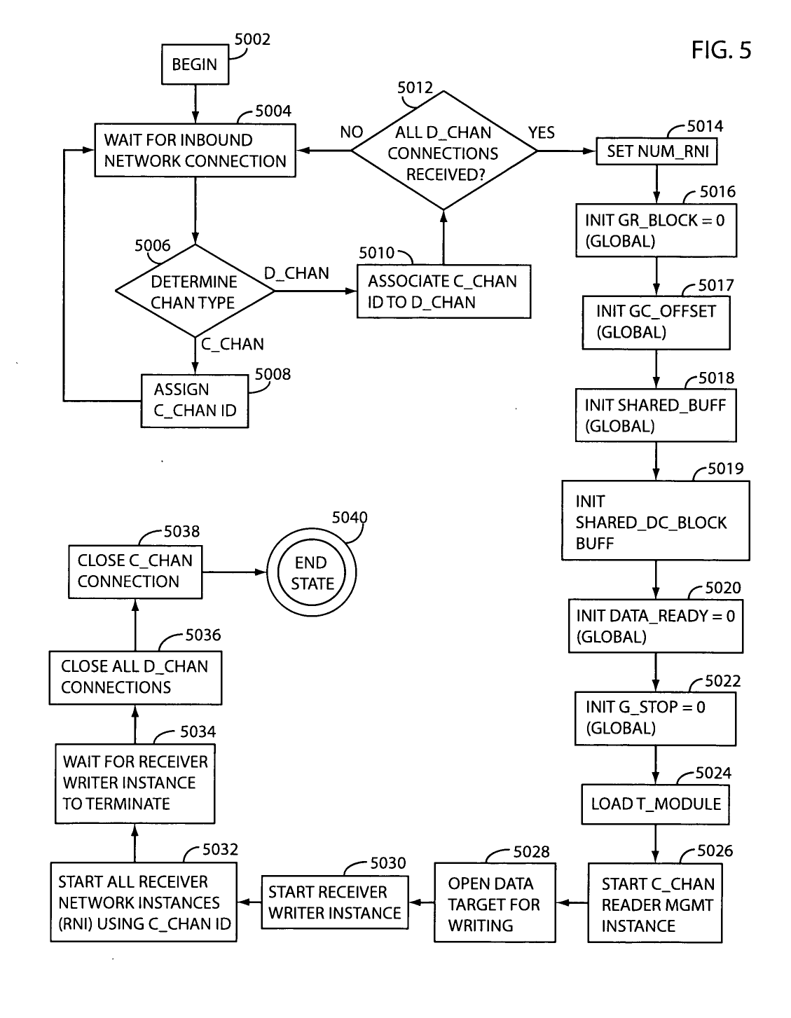

In order for the 1000 process to complete establishment of the command channel (1020), the receiver system (13006) may assign a command channel id (Refer to FIGS. 5—5008) and respond to the sender system (13002) with a command channel preamble with a modified command channel identification (9004) (C_CHAN ID) set to reflect a value to be used for subsequent communication between the sender system (13002) and the receiver system (13006) for a data transmission job.

The 1000 process may then proceed to set the C_CHAN ID (1022) which is a shared value containing the command channel identification value encoded in the preamble returned to the sender system (13002) by the receiver system (13006). The C_CHAN_ID (1022) is used by sender system (13002) processes 1000, 3000, and 4000 for communication with the receiver system (13006).

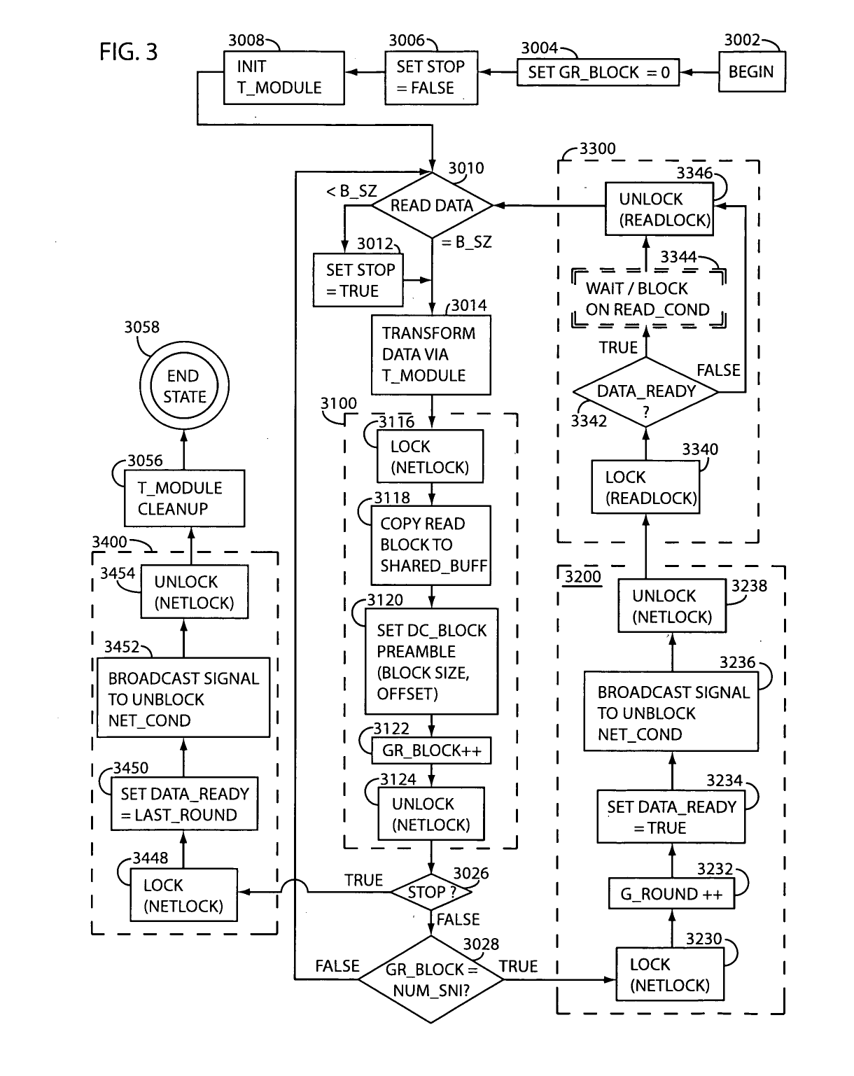

Once the command channel is established, the process 1000 may start a command channel reader management instance (1024) which waits for commands to be received on the command channel established by 1020. The process 1000 may start the sender reader process 3000 in operation (1026) (refer to FIG. 3) using the command channel identification number assigned by the receiver system (13006) and set by (1022).

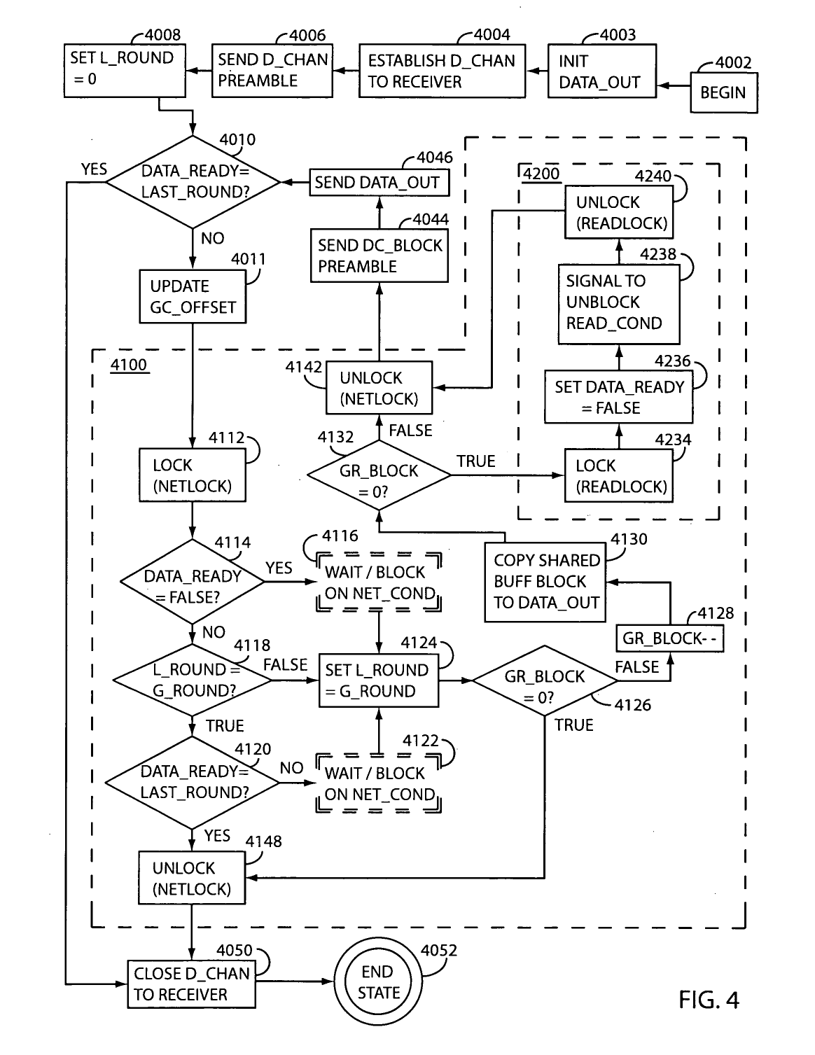

The process 1000 may start the sender network instance(s) 4000 in operation (1028) (refer to FIG. 4) using the command channel identification number assigned by the receiver system (13006) and set by (1022). The sender network instance(s) 4000 set an internally used identification value referred to as the SNI ID. The sender reader process 3000 and the sender network instance(s) 4000 work together to read data from the data source (1014) and transmit that data over a network (13004) to a receiver system (13006).

The process 1000 may proceed to (1030) to wait on the sender reader process 3000 to terminate. Once the sender reader process 3000 terminates, the process 1000 may proceed to (1032) to wait on the sender network instance(s) 4000 to terminate. Once the sender network instance(s) 4000 terminate, the process 1000 may proceed to (1034) to close the data source (1014). The process 1000 may proceed to (1036) to transmit a command on the command channel notifying the receiver system (13006) that all data has been sent and may then close the command channel, and terminate at operation (1038).

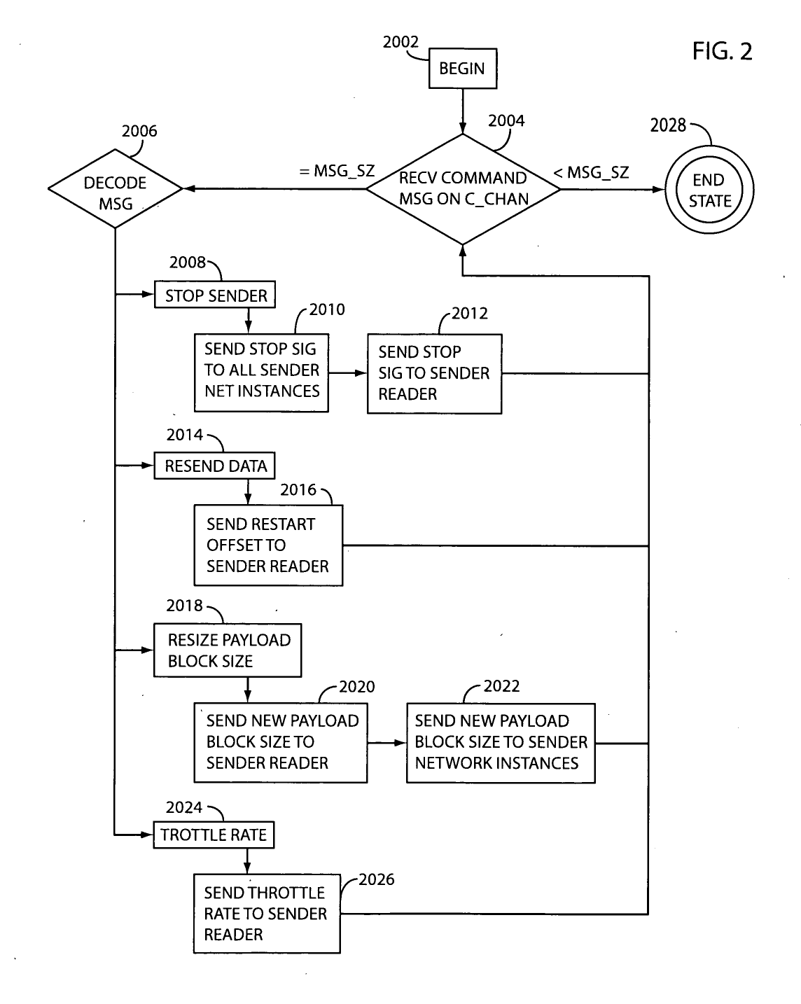

FIG. 2

The process 2000 begins at operation (2002) which configures the sender system processor (12002) for the remaining operations within the process. Once the sender system hardware is configured for processing further instructions, the 2000 process may proceed to operation (2004) to wait for properly formatted command messages to be sent from the receiver system (13006) to the sender system (13002) on the command channel established by (1020). If the command channel is closed when process 2000 proceeds to (2004), process 2000 may proceed to (2028) and terminate.

Upon receipt of a command message by (2004), if the command message is truncated or if the command channel is closed by the receiver system (13006) or other external factors, the process 2000 may proceed to (2028) and terminate. If a proper command message is received by (2004), the process 2000 may proceed to (2006) to decode the command message.

Operation (2006) decodes the command message and the process 2000 may proceed to the appropriate operation (2008, 2014, 2018, or 2024).

If operation (2006) receives a STOP SENDER command, process 2000 may proceed via (2008) to operation (2010) to send a STOP SIGNAL to the sender network instance(s) 4000 and then proceed to operation (2012) to send a STOP SIGNAL to the sender reader process 3000. The process 2000 may then proceed to (2004).

If operation (2006) receives a RESEND DATA command, process 2000 may proceed via (2014) to operation (2016) to modify the data reader offset value (GC_OFFSET) (1005) in turn causing the sender reader process 3000 on the next read operation to seek to the GC_OFFSET value. The GC_OFFSET (1005) value in the sender reader process is updated after data read operations to maintain position information within the data stream. If the offset value is reset to a new value, the subsequent reads performed by the sender reader process 3000 may use the new value as a starting data position offset value. The process 2000 may then proceed to (2004).

If operation (2006) receives a RESIZE PAYLOAD BLOCK SIZE command, process 2000 may proceed via (2018) to operation (2020) to modify the payload data block read-size in the sender reader process 3000 (B_SZ). The process 2000 may proceed to operation (2022) to modify the payload data block transmission size in the sender network instance(s) 4000. Subsequent reads performed by the sender reader 3000 and data transmissions performed by the sender network instance(s) 4000 may use the new block size. The process 2000 may proceed to (2004).

If operation (2006) receives a THROTTLE RATE command, process 2000 may proceed via (2024) to operation (2026) to send a new transmission rate request to the sender reader process 3000. Some embodiments implement transmission throttle rate changes in the sender reader process 3000, some embodiments may implement throttle rate changes in the sender network instance(s) 4000, or some embodiments may not implement throttle rate controls. The process 2000 may proceed to (2004).

FIG. 3

The process 3000 begins at operation (3002) which configures the sender system processor (12002) for the remaining operations within the process. Once the sender system hardware is configured for processing further instructions, the 3000 process may set the GR_BLOCK counter (1004) to zero in operation (3004). The 3000 process may initialize and set the STOP boolean to FALSE in operation (3006). If a transformation module is in use, the 3000 process may initialize the transformation module (3008) to begin accepting data for transformation operations.

The process 3000 may proceed to operation (3010) to read data from the data source opened by (1014). The process 3000 reads data from the data source by a fixed block size (B_SZ) which can be modified via a command message (2018). If the (3010) operation reads less than a full block of data from the data source (1014), the STOP boolean (3006) may be set to TRUE. If the 3010 operation reads an entire block of data from the data source (1014), the process 3000 may proceed to (3014) to transform the data via a transformation module (Refer to FIG. 14).

The process 3000 may then proceed to a mutually atomic set of operations contained within [3100]. The operations in [3100] are mutually atomic with operations within [4100]. The process 3000 atomically sets a lock on NETLOCK in operation (3116). The process 3000 may then safely copy a block read from the data source (1014) in operation (3010) to the SHARED_BUFF (1006) in operation (3118). The process 3000 may set the data channel block preamble PAYLOAD SIZE (11006) and PAYLOAD OFFSET (11008) values and store the data channel block preamble to the SHARED BUFF (1006) in operation (3120). A data block has been read from the data source (1014), the data channel block preamble has been created, and the SHARED_BUFF (1006) now stores these values for later processing. The process 3000 increments the shared GR_BLOCK round counter (1004) by one block in operation (3122) and unlocks the lock set on NETLOCK in operation (3124). The process 3000, having completed operations within [3100], may continue without the need for mutually atomic operations until such time that operations within [3100] may be performed again.

The process 3000 may proceed to (3026) to test the STOP boolean (3006).

If the STOP boolean (3006) is set to true when evaluated by operation (3026), the process 3000 may then proceed to a mutually atomic set of operations contained within [3400]. The operations in [3400] are mutually atomic with operations within [4100]. The process 3000 atomically sets a lock on NETLOCK in operation (3448). The process 3000 may then safely set the shared DATA_READY status indicator (1008) to LAST_ROUND in operation (3450). The process 3000 may then broadcast a signal to unblock NET_COND in operation (3452) and unlocks the lock set on NETLOCK in operation (3454). The process 3000, having completed operations within [3400], may continue without the need for mutually atomic operations. The process 3000 may proceed to (3056) to perform any T_MODULE cleanup operations, and then to (3058) to terminate.

If the STOP boolean (3006) is set to false when evaluated by operation (3026), the process 3000 may then proceed to (3028) to evaluate if the shared GR_BLOCK round counter (1004) equals NUM_SNI (1018). If the shared GR_BLOCK round counter (1004) is equal to NUM_SNI (1018), the sender reader process 3000 has read enough blocks to fill a data transmission round and may proceed to atomic operations within [3200] beginning with (3230). If the shared GR_BLOCK round counter (1004) is less than NUM_SNI (1018), the sender reader process 3000 has not read enough blocks to fill an entire data transmission round and may proceed to (3010).

When operation (3028) determines that the shared GR_BLOCK round counter (1004) equals NUM_SNI (1018), the process 3000 may proceed to a mutually atomic set of operations contained within [3200]. The operations in [3200] are mutually atomic with operations within [4100]. The process 3000 atomically sets a lock on NETLOCK in operation (3230). The process 3000 increments the shared G_ROUND counter (1010) by one in operation (3232) and may proceed to operation (3234) to set the shared DATA_READY status indicator (1008) to TRUE. The process 3000 may proceed to (3236) to broadcast a signal to unblock NET_COND and unlock the lock set on NETLOCK in operation (3238). The process 3000, having completed operations within [3200], may continue without the need for mutually atomic operations until such time that operations within [3200] may be performed again.

The process 3000 may proceed to a mutually atomic set of operations contained within [3300]. The operations in [3300] are mutually atomic with operations within [[4200]]. The process [3000] atomically sets a lock on READLOCK in operation (3340). The process 3000 may then evaluate the shared DATA_READY status indicator (1008) in operation (3342). If the shared DATA_READY status indicator (1008) is set to TRUE in (3342), the process 3000 may proceed to operation (3344) and wait-block on READ_COND. The wait-block operation unlocks the lock set on READLOCK, blocks on READ_COND, and upon receiving a signal to unblock on READ_COND, the wait-block operation will atomically relock the READLOCK and proceed to operation (3346). If the shared DATA_READY status indicator (1008) is set to FALSE in (3342), the process 3000 may proceed to operation (3346) to unlock the lock set on READLOCK. The process 3000, having completed operations within [3300], may continue without the need for mutually atomic operations until such time that operations within [3300] may be performed again.

The process 3000 may proceed to (3010) to continue reading data.

FIG. 4

The process 4000 begins at operation (4002) which configures the sender system processor (12002) for the remaining operations within the process. Once the sender system hardware is configured for processing further instructions, the 4000 process may initialize a DATA_OUT buffer in operation (4003) which is used to store a data block and associated data channel preamble for transmission to the receiver system (13006).

The process 4000 may then proceed to establish a data channel (D_CHAN) to the receiver system (13006) in (4004). To establish a data channel, the 4000 process may transmit a data channel preamble (10000) via a network (13004) to the receiver system (13006) in operation (4006).

The data channel preamble channel type (10002) (CHAN TYPE) is set to a value representative of a data channel.

The data channel preamble command channel identification (10004) (C_CHAN ID) is set to the C_CHAN ID (1022) negotiated by the 1000.

The data channel preamble data channel identification (10006) (D_CHAN ID) is set to the internal identification number of the sender network instance (SNI ID).

Once the 4000 process has established a data channel and sent the data channel preamble, the 4000 process may initialize and set a local round counter (L_ROUND) to zero in operation (4008).

The 4000 process may proceed to (4010) to test the DATA_READY status indicator (1008). If the (4010) operation determines that DATA_READY (1008) indicates the LAST_ROUND status, the 4000 process may proceed to (4050) to close the data channel connection to the receiver system (13006) and then to (4052) to terminate.

If the (4010) operation determines that DATA_READY (1008) does not indicate the LAST_ROUND status, the process 4000 may then update the GC_OFFSET (1005) to the offset of the last data block plus the data block size of the previously transmitted data block by the process 4000 if said value is greater than the value currently stored in GC_OFFSET (1005). This guarantees that GC_OFFSET (1005) contains a data reader starting position offset in the event the data transmission is restarted.

The process 4000 may then proceed to a mutually atomic set of operations contained within [4100]. The operations within [4100] are mutually atomic with operations within [3100, 3200, and 3400]. The process 4000 atomically sets a lock on NETLOCK in operation (4112).

The process 4000 may then proceed to (4114) to determine if the DATA_READY status indicator (1008) is set to FALSE. If the DATA_READY indicator (1008) is set to FALSE in (4114), the process 4000 may proceed to (4116) and wait-block on NET_COND. The wait-block operation unlocks the lock set on NETLOCK, blocks on NET_COND, and upon receiving a signal to unblock on NET_COND, the wait-block operation will atomically relock the NETLOCK and proceed to operation (4124). If the DATA_READY indicator (1008) is not set to FALSE in (4114), the process 4000 may proceed to (4118) to determine if the local round counter (L_ROUND) (4008) is equal to the global round counter (G_ROUND) (1010). If the local round counter (L_ROUND) (4008) is not equal to the global round counter (G_ROUND) (1010) in (4118), the process 4000 may proceed to (4124). If the local round counter (L_ROUND) (4008) is equal to the global round counter (G_ROUND) (1010) in (4118), the process 4000 may proceed to (4120) to determine if the DATA_READY indicator (1008) is set to LAST_ROUND. If the DATA_READY indicator (1008) is not set to LAST_ROUND in (4120), the process 4000 may proceed to (4122) and wait-block on NET_COND. The wait-block operation unlocks the lock set on NETLOCK, blocks on NET_COND, and upon receiving a signal to unblock on NET_COND, the wait-block operation will automatically relock the NETLOCK and proceed to operation (4124). If the DATA_READY indicator (1008) is set to LAST_ROUND in (4120), the process 4000 may proceed to operation (4148) to unlock the lock set on NETLOCK and having completed operations within [4100], may proceed to (4050) to close the data channel to the receiver system (13006) and then to (4052) to terminate.

The process 4000 sets the local round counter (L_ROUND) (4008) to the global round counter (G_ROUND) (1010) in operation (4124) and may then proceed to (4126) to determine if the global round block counter (GR_BLOCK) (1004) is equal to zero.

If the global round block counter (GR_BLOCK) (1004) is equal to zero in (4126), the process 4000 may proceed to (4148) to unlock the lock set on NETLOCK and having completed operations within [4100], may proceed to (4050) to close the data channel to the receiver system (13006) and then to (4052) to terminate. If the global round block counter (GR_BLOCK) (1004) is not equal to zero in (4126), the process 4000 may proceed to (4128) to decrement the global round block counter (GR_BLOCK) (1004) by one.

The process 4000 may then proceed to (4130) to copy a data block and associated data channel block preamble (DC_BLOCK) from the SHARED_BUFF (1006) to a local buffer (DATA_OUT) (4003). The process 4000 may then proceed to (4132) to determine if the global round block counter (GR_BLOCK) (1004) is equal to zero.

If the global round block counter (GR_BLOCK) (1004) is not equal to zero in (4132), the process 4000 may proceed to (4142). If the global round block counter (GR_BLOCK) (1004) is equal to zero in (4132), the 4000 process may then proceed to a mutually atomic set of operations contained within [[4200]]. The operations within [[4200]] are mutually atomic with operations within [3300]. The 4000 process atomically sets a lock on READLOCK in operation (4234). The process 4000 may then proceed to (4236) to set the DATA_READY status indicator (1008) to FALSE. The 4000 process may then proceed to (4238) to send a signal to unblock READ_COND. The process 4000 may then proceed to (4240) to unlock the lock set on READLOCK and having completed operations within [[4200]], may proceed to (4142).

The process 4000 in operation (4142) unlocks the lock set on NETLOCK and having completed operations within [4100], may proceed to (4044).

The process 4000 sends the data channel block preamble (DC_BLOCK) stored in the DATA_OUT buffer (4003) to the receiver system (13006) in operation (4044). The process 4000 may proceed to (4046) to send the data block stored in DATA_OUT (4003) to the receiver system (13006). Once the data channel block (DC_BLOCK) preamble and associated data block have been sent to the receiver system (13006), the 4000 process may proceed to operation (4010).

FIG. 5

FIG. 5 is a flowchart illustrating a process consisting of a set of operations for receiving data from a network (13004) transmitted by a sender system (13002) to a receiver system (13006) in accordance with an example embodiment. Additional embodiments may be realized by changing the order of operations within the process or by splitting the set of operations and/or additional operations across multiple processes.

The process 5000 begins at operation (5002) which configures the receiver system processor (12002) for the remaining operations within the process. Once the receiver system hardware is configured for processing further instructions, the 5000 process may proceed to operation (5004) to wait for an inbound network connection. In operation (5004), the process 5000 listens for a network connection to be established from the sender system (13002) to the receiver system (13006). Once a network connection has been established between the sender system (13002) and the receiver system (13006), the process 5000 may proceed to operation (5006) to determine the type of communication channel (CHAN TYPE) that has been received by the receiver system (13006). The CHAN TYPE is determined by inspection of the first field of the preamble sent by a sender system (13002) to the receiver system (13006).

If the preamble sent by the sender system (13002) has a CHAN TYPE set to a value representative of a command channel (9002), the process 5000 processes the preamble as a command channel preamble (See FIG. 9) and interprets the receipt of a command channel preamble as the start of a new data transmission job. The number of parallel streams also known as the number of data channels, or hence forth—the NUM D_CHAN value (9006) to expect is contained in the command channel preamble (9006). The NUM D_CHAN (9006) value informs the process 5000 of how many data channels to expect from the sender system (13002) for a specific data transmission job.

If the command channel preamble contains an optional metadata information block (9008) (METADATA INFO), the process 5000 may use this information in operation (5028) when opening the data target for writing. If the command channel preamble contains an optional data target information block (9009), the process 5000 may use this information in operation (5028) when opening the data target for writing.

If the metadata information (9008) (METADATA INFO) block contains a default value representing that the data being received is streaming data and therefore does not require metadata external to the data stream, the process 5000 may use external data routing information and/or storage information external to the scope of the present subject for instructing the (5028) operation when opening the data target for writing.

The command channel preamble may optionally contain transformation module configuration information (9010) (T_MODULE INFO) indentifying a transformation module method or set of transformation module methods and associated configuration information for proper transformation of data received by the receiver system (13006).

The command channel preamble may optionally contain a data size (9012) to indicate the total size of data being transmitted by the sender system (13002) to the receiver system (13006). Embodiments transmitting streaming data, or when data size is unknown are not required to include a data size value.

The command channel preamble may optionally contain a data target writer starting offset (9014) to indicate the starting data position offset from the data source being transmitted.

If the operation (5006) determines that a command channel has been received by operation (5004), the 5000 process may proceed to (5008) to assign a command channel identification value. The command channel preamble (9004) (C_CHAN ID) is set by operation (5008) to the assigned command channel identification value and the original command channel preamble with the modified C_CHAN ID (9004) is transmitted back to the sender system (13002) to complete the establishment of the command channel (refer to 1020, 1022). The process 5000 may then proceed to (5004).

If the preamble sent by the sender system (13002) has a CHAN TYPE set to a value representative of a data channel (10002), the process 5000 processes the preamble as a data channel preamble (See FIG. 10). The command channel identification (10004) (C_CHAN ID) is used to associate the data channel with a specific data transmission job and command channel. The data channel identification (10006) (D_CHAN ID) optionally maps data channels between the sender system (13002) and the receiver system (13006). Some embodiments may map specific data transmission round payload block offsets by data channel which requires a mapping of data channels between the sender system and the receiver system for proper payload block offset calculation. The illustrated embodiment does not require that data channels transmit specific transmission round payload block offsets. The illustrated embodiment uses data channel block (DC_BLOCK) preambles (refer to FIG. 11) to decode payload block offsets.

If the operation (5006) determines that a data channel has been received by operation (5004), the 5000 process may proceed to (5010) to associate the data channel with a specific data transmission job and command channel. The 5000 process may then proceed to (5012) to determine if all data channels have been established between the sender system (13002) and the receiver system (13006).

If the command channel and all associated data channels for a specific data transmission job have not yet been received, the 5000 process may proceed to (5004) to wait for additional network connections.

If the command channel and all associated data channels have been received for a specific transmission job, the 5000 process is now ready to proceed with operations specific to a particular transmission job, command channel, and set of data channels. The example embodiment allows for simultaneous and mutually exclusive data transmission jobs to be transmitted from a sender system (13002) or set of sender systems (13002) to the receiver system (13006). The example embodiment may clone itself and establish a parent and child relationship between the two resulting instances of the process 5000. This is commonly referred to as “forking a process”. The parent process may proceed to (5004) to continue receiving network connections to accept additional data transmission jobs. The child process may proceed to (5014) to perform the operations necessary for the current data transmission job. Other embodiments may start an additional process to perform operations necessary for the current data transmission job. Still other embodiments may not be capable of processing multiple independent data transmission jobs by an instance of the 5000 process and may simply proceed to (5014).

Once the 5000 process has received the command channel and all associated data channels for a specific data transmission job, the 5000 process may proceed to allocate and initialize shared data structures for usage between the 1000 process and other processes within the receiver system (13006).

The process 5000 sets the number of receiver network instances (NUM_RNI) (5014) equal to the NUM D_CHAN value (9006) in the command channel preamble. The number of blocks in a data transmission round is equal to the number of receiver network instances and the number of receiver network instances is equal to the number of data channels established by the sender system (13002) to the receiver system (13006) for a specific data transmission job.

GR_BLOCK (5016) is a shared transmission round block counter used by processes 5000, 7000, and 8000 to track the number of blocks processed in a transmission round.

GC_OFFSET (5017) is a shared offset counter used by processes 5000 and 8000 to store the offset address of the data target to be used if the data transmission is restarted.

SHARED_BUFF (5018) is a shared data block storage structure used to temporarily store blocks for each transmission round and is used by processes 5000, 7000, and 8000.

SHARED_DC_BLOCK BUFF (5019) is a shared data channel block preamble storage structure used to temporarily store data channel block preambles and is used by processes 5000, 7000, and 8000.

DATA_READY (5020) is a shared boolean status indicator which may have a value of true or false and is used by processes 5000, 7000, and 8000.

G_STOP (5022) is a shared status counter which is used by processes 5000, 7000, and 8000.

Once initialization of the shared data structures is complete, the 5000 process may proceed to (5024) to optionally load and initialize an external data transformation module depicted in the figures as T_MODULE (Refer to FIG. 15).

Some embodiments may use data transformation module that may implement one or more of the following data transformation module methods: reversion of data deduplication methods (15008), decryption methods (15006), decompression methods (15010), and/or data reformat methods (15012). The 5000 process may then proceed to (5026).

If an embodiment does not make use of a transformation module, the 5000 process may skip operation (5024) and proceed to (5026).

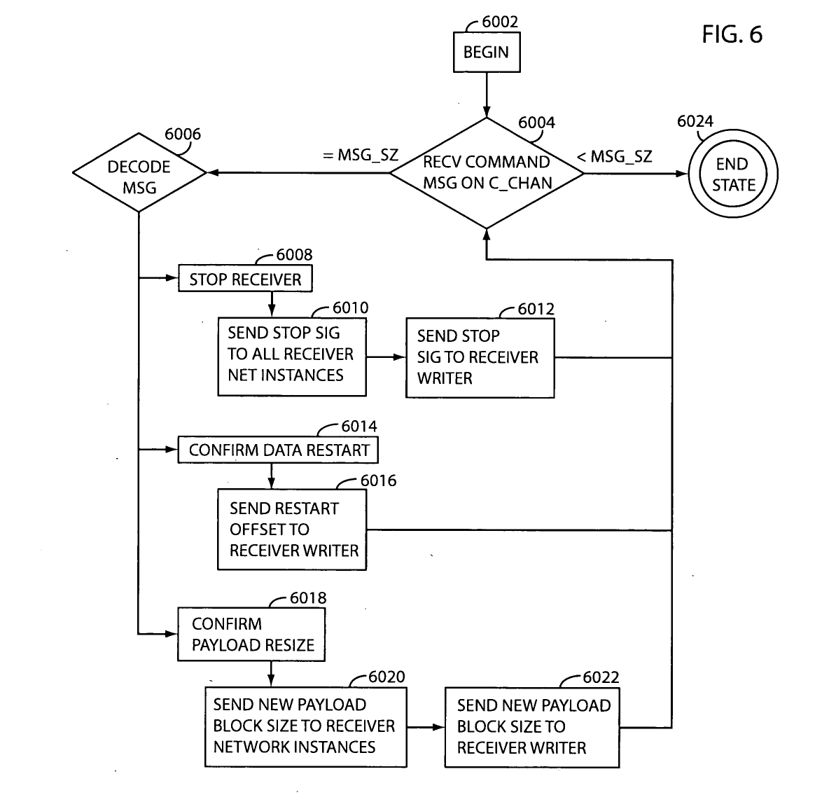

The process 5000 in operation (5026) may start a command channel reader management instance (Refer to FIG. 6) which waits for commands to be received on the command channel established by (5004) (and 1020 on the sender side).

The process 5000 uses the METADATA INFO (9008) and the data target information block (9009) contained in the command channel preamble to select the data target in operation (5028).

The process 5000 may then proceed to (5028) to open for writing the data target which may be one of: a network socket, a named pipe, a regular command pipe writing to standard output, a file, a directory, a block device, a character device, or a data terminal directed by a human operator for writing and seek to the data target writer starting offset as specified in the command channel preamble START OFFSET (9014).

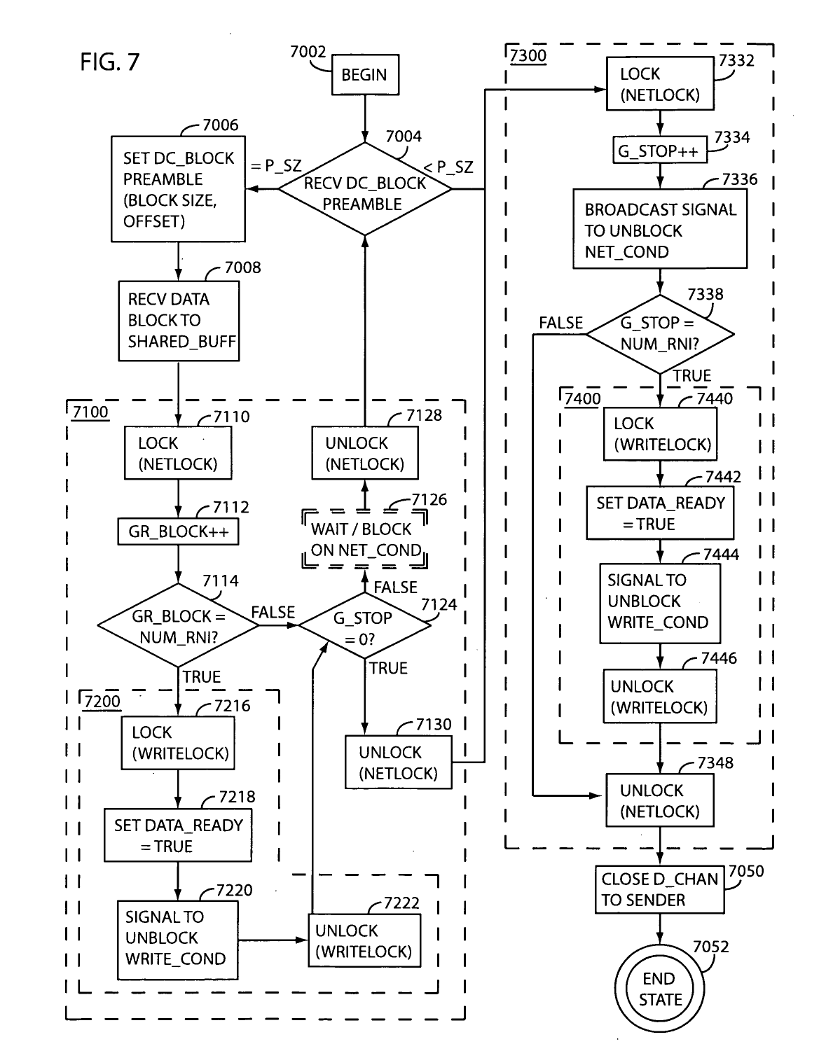

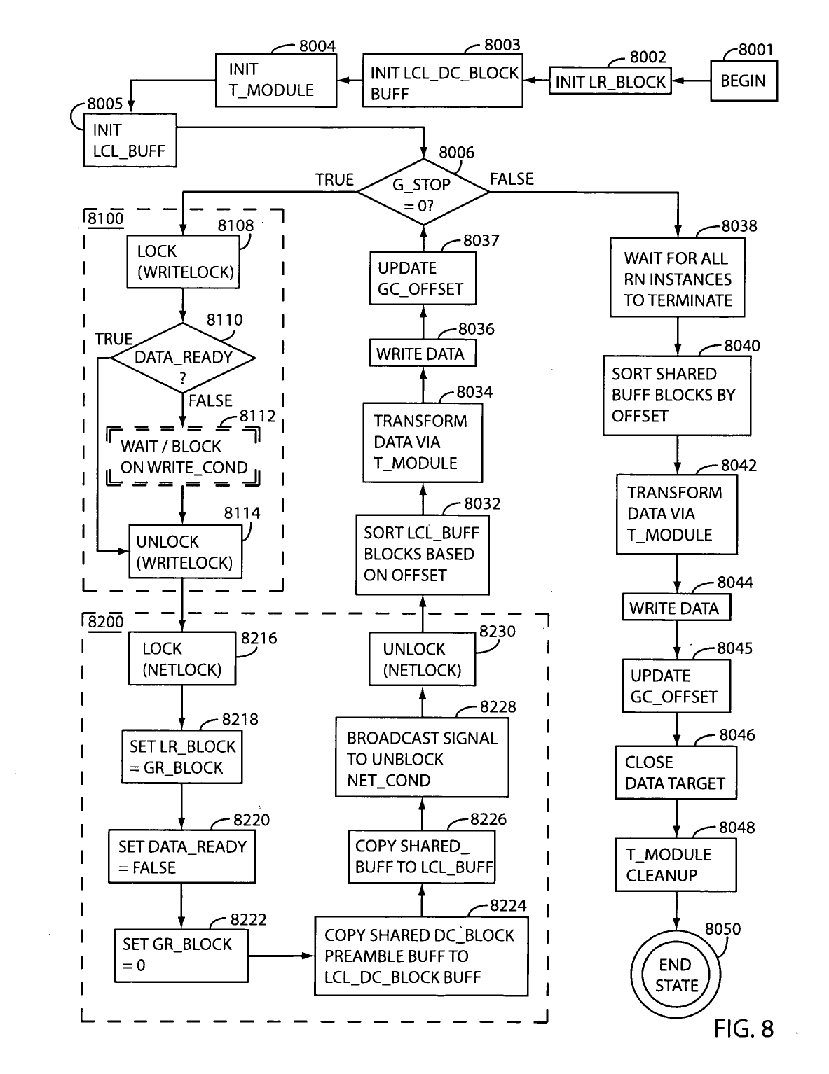

The process 5000 may start the receiver writer process 8000 in operation (5030) (refer to FIG. 8). The process 5000 may start the receiver network instance(s) 7000 in operation (5032) (refer to FIG. 7) using the command channel identification number (5008). The receiver network instance(s) 7000 set an internally used identification value referred to as the RNI ID. The receiver writer process 8000 and the receiver network instance(s) 7000 work together to receive data over a network (13004) from a sender system (13002) and write the data to the data target (5028).

The process 5000 may proceed to (5034) to wait on the receiver writer process 8000 to terminate. The process 5000 may then proceed to (5036) to close all data channel (D_CHAN) connections. The process 5000 may then proceed to (5038) to close the command channel (C_CHAN) connection. Once the process 5000 has closed the data and command channel connections, the process 5000 may proceed to (5040) and terminate.

FIG. 6

The process 6000 begins at operation (6002) which configures the receiver system processor (12002) for the remaining operations within the process. Once the receiver system hardware is configured for processing further instructions, the 6000 process may proceed to operation (6004) to wait for properly formatted command messages to be sent from the sender system (13002) to the receiver system (13006) on the command channel established by (5004). If the command channel is closed when process 6000 proceeds to (6004), the process 6000 may proceed to (6024) and terminate.

Upon receipt of a command message by (6004), if the command message is truncated or if the command channel is closed by the sender system (13002) or other external factors, the process 6000 may proceed to (6028) and terminate. If a proper command message is received by (6004), the process 6000 may proceed to (6006) to decode the command message.

Operation (6006) decodes the command message and the process 6000 may proceed to the appropriate operation (6008, 6014, or 6018).

If operation (6006) receives a STOP RECEIVER command, process 6000 may proceed via (6008) to operation (6010) to send a STOP SIGNAL to the receiver network instance(s) 7000 and process 6000 may then proceed to operation (6012) to send a STOP SIGNAL to the receiver writer process 8000. The process 6000 may then proceed to (6004).

If operation (6006) receives a CONFIRM DATA RESTART command, process 6000 may proceed via (6014) to operation (6016) to modify the data writer offset value (GC_OFFSET) (5017) in the receiver writer process (refer to FIG. 8). The GC_OFFSET (5017) offset value in the receiver writer process 8000 is updated after data write operations by (8037) to maintain position information within the data stream. If the offset value is reset to a new value, the subsequent writes performed by the receiver writer process 8000 may use the new value as a starting data position offset value. The process 6000 may then proceed to (6006).

If operation (6006) receives a CONFIRM PAYLOAD BLOCK RESIZE command, process 6000 may proceed via (6018) to operation (6020) to modify the payload data block write size in the receiver writer process 8000. The process 6000 may proceed to operation (6022) to modify the payload data block transmission size (P_SZ) in the receiver network instance(s) 7000. Subsequent data transmissions received by the receiver network instance(s) 7000 may use the new block size. The process 6000 may proceed to (6004).

FIG. 7

The process 7000 may have multiple instances operating in parallel with other instances of the 7000 process. What follows is a description of a single instance of the 7000 process, which will be referred to as the instance 7000.

For a specific data transmission job between a sender system (13002) and a receiver system (13006):
Specific data channels having a data channel identification (D_CHAN ID) are assigned to specific sender network instances (instances of the 4000 process) having a sender network instance identification (SNI ID).
Specific data channels having a data channel identification (D_CHAN ID) are assigned to specific receiver network instances (instances of the 7000 process) having a receiver network instance identification (RNI ID).
The number of instances of the 7000 process is equal to the NUM_RNI value established by the 5000 process in operation (5014).
The number of data channels (D_CHAN) is equal to the NUM_RNI value established by the 5000 in operation (5014).
Since the number of data channels (D_CHAN) established between the sender system (13002) and the receiver system (13006) are equal, the NUM_SNI value established by the process 1000 in operation (1018) is equal to the NUM_RNI value established by the 5000 process in operation (5014)
The number of data channels (D_CHAN) is equal to the NUM_SNI value established by the 1000 process in operation (1018).
The number of instances of the 4000 process is equal to the NUM_SNI value established by the 1000 process in operation (1018).
Since each data channel transmits one data block for each data transmission round, the number of blocks in a data transmission round is equal to the number of data channels.
The number of blocks that can be stored by the SHARED_BUFF initialized in process 5000 in operation (5018) is equal to the NUM_RNI value established by the 5000 process in operation (5014).
The number of blocks that can be stored by the SHARED_BUFF initialized in process 1000 in operation (1006) is equal to the NUM_SNI value established by the 1000 process in operation (1018).
Finally, the values for NUM_SNI (1018), NUM_RNI (5014), the number of data channels in use between a sender system (13002) and a receiver system (13006), the number of instances of the 7000 process, the number of instances of the 4000 process, the number of blocks in a data transmission round, the number of blocks that can be stored in the SHARED_BUFF (1006) on the sender system (13002), and the number of blocks that can be stored in the SHARED_BUFF (5018) on the receiver system (13006) are equal.

The instance 7000 begins at operation (7002) which configures the receiver system processor (12002) for the remaining operations within the instance. Once the receiver system hardware is configured for processing further instructions, the instance 7000 may proceed to operation (7004) to wait for a properly formatted data channel block (DC_BLOCK) preamble to be sent from the sender system (13002) to the receiver system (13006) on the corresponding data channel (D_CHAN). If the D_CHAN is closed or if a received data channel bock (DC_BLOCK) preamble is truncated due to the D_CHAN being closed by the sender system (13002) or other external factors, the instance 7000 may proceed to a mutually atomic set of operations contained within [7300].

Once a proper DC_BLOCK preamble is received by operation (7004), the instance 7000 may proceed to (7006) to store the DC_BLOCK preamble payload block size (11006) and payload offset position (11008) in the SHARED_DC_BLOCK buffer (5019) for later use by the instance 7000 and process 8000. The 7000 instance may then proceed to (7008) to receive a data block on the corresponding D_CHAN with a length matching the block size stored from the DC_BLOCK preamble in operation (7006).

Once the data block has been received in operation (7008), the instance 7000 may proceed to a mutually atomic set of operations contained within [7100]. The operations in [7100] are mutually atomic with operations within other instances of the 7000 process having mutually atomic instances of operation blocks [7100] and [7300] as well as operations within the 8000 process in the [8200] operation block. The instance 7000 atomically sets a lock on NETLOCK in operation (7110). The instance 7000 may then increment the global round block (GR_BLOCK) counter (5016) by one and may proceed to (7114). If the GR_BLOCK counter (5016) is equal to the number of receiver network instances (NUM_RNI) (5014) in operation (7114), the instance 7000 may proceed to a mutually atomic set of operations contained within [[7200]]. If the GR_BLOCK counter is not equal to NUM_RNI (5014) in operation (7114), the instance 7000 may proceed to operation (7124).

The operations in [[7200]] are mutually atomic with operations within other instances of the 7000 process having mutually atomic instances of the operation blocks [[7200]] and [[7400]] as well as operations within the 8000 process in the [8100] operation block. The instance 7000 atomically sets a lock on WRITELOCK in operation (7216). The instance 7000 may then set the DATA_READY boolean (5020) to a value of TRUE. The instance 7000 may then send a signal to unblock WRITE_COND in operation (7220) and unlocks the lock set on WRITELOCK in operation (7222). The instance 7000, having completed operations within [[7200]], may continue without the need for mutually atomic operations in [[7200]] until such time that operations within [[7200]] may be performed again. The instance 7000 may proceed to (7124).

If the G_STOP status value (5022) is greater than zero in operation (7124), the instance 7000 may proceed to operation (7130) to unlock the lock set on NETLOCK and may then proceed to a mutually atomic set of operations contained within [7300]. If the G_STOP status value (5022) is equal to zero, the instance 7000 may proceed to operation (7126) and wait-block on NET_COND. The wait-block operation unlocks the lock set on NETLOCK, blocks on NET_COND, and upon receiving a signal to unblock on NET_COND, the wait-block operation automatically relocks the NETLOCK and proceeds to operation (7128). Operation (7128) unlocks the lock set on NETLOCK. The instance 7000, having completed operations within [7100], may continue without the need for mutually atomic operations within [7100] until such time that operations within [7100] may be performed again. The instance 7000 may proceed to (7004).

The instance 7000, having met conditions in operation (7004) or (7124) (via 7130), may proceed to a mutually atomic set of operations contained within [7300]. The operations in [7300] are mutually atomic with operations within other instances of the 7000 process having mutually atomic instances of the operation blocks [7100] and [7300] as well as operations within the 8000 process in the [8200] operation block. The instance 7000 atomically sets a lock on NETLOCK in operation (7332). The instance 7000 may then increment the G_STOP counter (5022) by one in operation (7334). The instance 7000 may then broadcast a signal to unblock NET_COND in operation (7336) and tests the value of G_STOP (5022) in operation (7338).

If G_STOP (5022) is equal to NUM_RNI (5014) in operation (7338), the instance 7000 may proceed to a mutually atomic set of operations contained within [[7400]]. The operations within [[7400]] are mutually atomic with operations within other instances of the 7000 process having mutually atomic instances of the operation blocks [[7200]] and [[7400]] as well as operations within the 8000 process in the [8100] operation block. The instance 7000 atomically sets a lock on WRITELOCK in operation (7440). The instance 7000 may then set the DATA_READY boolean (5020) to a value of TRUE. The instance 7000 may then send a signal to unblock WRITE_COND in operation (7444) and then operation (7446) may unlock the lock set on WRITELOCK. The instance 7000, having completed operations within [[7400]], may continue without the need for mutually atomic operations within [[7400]]. The instance 7000 may proceed to (7348).

If G_STOP (5022) is not equal to NUM_RNI (5014) in operation (7338), the instance 7000 may proceed to (7348).

Operation (7348) unlocks the lock set on NETLOCK. The instance 7000, having completed operations within [7300], may continue without the need for mutually atomic operations within [7300]. The instance 7000 may proceed to (7050) to close the specific D_CHAN used by the specific instance of the 7000 process. The instance 7000 may proceed to (7052) and terminate.

FIG. 8

The process 8000 begins at operation (8001) which configures the receiver system processor (12002) for the remaining operations within the process. Once the receiver system hardware is configured for processing further instructions, the process 8000 may proceed to initialize and set the local round block counter (LR_BLOCK) to zero in operation (8002). The process 8000 may then allocate and initialize a local data block buffer (LCL_DCBLOCK) in operation (8003).

If a data transformation module is in use by a specific data transmission job, the process 8000 may initialize the transformation module (8004) to begin accepting data for transformation operations. The process 8000 may then proceed to (8005) to allocate and initialize a local buffer (LCL_BUFF).

The process 8000 may proceed to (8006) to evaluate G_STOP (5022).

In operation (8006), if G_STOP (5022) is not equal to zero, the process 8000 may proceed to (8038). If G_STOP (5022) is equal to zero, the process 8000 may proceed to a mutually atomic set of operations contained within [8100]. The operations within [8100] are mutually atomic with operation blocks [[7200]] and [[7400]] in all instances of the 7000 process for a specific data transmission job. The process 8000 atomically sets a lock on WRITELOCK in operation (8108). The process 8000 may then evaluate the DATA_READY boolean (5020) in operation (8110). If the DATA_READY boolean (5020) is equal to a value of FALSE in operation (8110), the process 8000 may proceed to (8112) and wait-block on WRITE_COND. The wait-block operation unlocks the lock set on WRITELOCK, blocks on WRITE_COND, and upon receiving a signal to unblock on WRITE_COND, the wait-block operation automatically relocks the WRITELOCK and proceeds to operation (8114). If the DATA_READY boolean (5020) is equal to a value of TRUE in operation (8110), the process 8000 may proceed to (8114). Operation (8114) unlocks the lock set on WRITELOCK, and having completed operations within [8100], the process 8000 may continue without the need for mutually atomic operations within [8100] until such time that operations within [8100] may be performed again.

The process 8000 may then proceed to a mutually atomic set of operations contained within [8200]. The operations within [8200] are mutually atomic with operation blocks [7100] and [7300] in all instances of the 7000 process for a specific data transmission job. The process 8000 atomically sets a lock on NETLOCK in operation (8216). The process 8000 may then set the local round block (LR_BLOCK) counter (8002) equal to the global round block (GR_BLOCK) counter (5016) in operation (8218). The process 8000 may proceed to (8220) to set the DATA_READY boolean (5020) to a value of FALSE. The process 8000 may proceed to (8222) to set the GR_BLOCK counter (5016) to zero. The process 8000 may proceed to (8224) to copy the shared data channel block (SHARED_DC_BLOCK) preamble buffer (5019) to the local data channel block preamble buffer (LCL_DC_BLOCK_BUFF) (8003). The 8000 process may proceed to (8226) to copy the shared data buffer (SHARED_BUFF) (5018) to the local data buffer (LCL_BUFF) (8005). The 8000 process may then broadcast a signal to unblock NET_COND in operation (8228) and may proceed to (8230) to unlock the lock set on NETLOCK. The process 8000, having completed operations within [8200], the process 8000 may continue without the need for mutually atomic operations within [8200] until such time that operations within [8200] may be performed again.

The process 8000 may proceed to (8032) to perform a sort operation on data blocks in the LCL_BUFF (8005) using data offset values contained in the LCL_DC_BLOCK_BUFF (8003). The process 8000 may then proceed to (8034) to transform data within the LCL_BUFF (8004) via the transformation module initialized by (8004).

The 8000 process may then write the data to the data target (5028) in operation (8036). The 8000 process may then proceed to operation (8037) to update the GC_OFFSET (5017) to the offset of the last data block plus the data block size of the previously written data block. This guarantees that GC_OFFSET (5017) contains a data writer starting position offset in the event the data transmission is restarted.

The 8000 process may then proceed to (8006) for another data transmission round.

If G_STOP (5022) is not equal to zero when evaluated by operation (8006), the process 8000 may proceed to (8038) and wait for all of the receiver network instances 7000 to terminate. Once the receiver network instances 7000 have terminated, the 8000 process may proceed to (8040) to perform a sort operation on any remaining data blocks which may be stored in the SHARED_BUFF (5018) using data offset values contained in the SHARED_DC_BLOCK preamble buffer (5019). The process 8000 may then proceed to (8042) to transform data within the SHARED_BUFF (5018) via the transformation module initialized by (8004).

The 8000 process may then write the data to the data target (5028) in operation (8044). The 8000 process may then proceed to operation (8045) to update the GC_OFFSET (5017) to the offset of the last data block plus the data block size of the previously written data block. This guarantees that GC_OFFSET (5017) contains a data writer starting position offset in the event the data transmission is restarted.

The 8000 process may then proceed to (8046) to close the data target (5028) for further write operations. The 8000 process may proceed to (8048) to perform any required data transformation module cleanup operations. The process 8000 may then proceed to (8050) to terminate.

FIG. 9

A command channel (C_CHAN) preamble (9000) comprises:
a CHAN TYPE value (9002) indicating that the preamble is of a command channel type,
a C_CHAN ID value (9004) indicating the command channel identification value,
a NUM D_CHAN value (9006) indicating the number of data channels associated with a specific command channel,
a METADATA information block (9008) having metadata information related to the data source,
a DATA TARGET information block (9009) having information about the data target,
a T_MODULE INFO information block (9010) having information about the transformation module,
a DATA SIZE value (9012) indicating the size of the data to be transmitted by the sender system (13002) to the receiver system (13006) if known when the transmission job begins,
a START OFFSET value (9014) indicating data source offset used by the data reader.

FIG. 10

A data channel (D_CHAN) preamble (10000) comprises:
a CHAN TYPE value (10002) indicating that the preamble is of a data channel type,
a C_CHAN ID value (10004) indicating the command channel identification value,
a D_CHAN ID value (10006) indicating the data channel identification value.

FIG. 11

A data channel block (DC_BLOCK) preamble (11000) comprises:
a CHAN TYPE value (11002) indicating that the preamble is of a data channel type,
a C_CHAN ID value (11004) indicating the command channel identification value,
a PAYLOAD SIZE value (11006) indicating the block size of the data block associated with this DC_BLOCK preamble,
a PAYLOAD SIZE value (11008) indicating the offset value of the data block associated with this DC_BLOCK preamble.

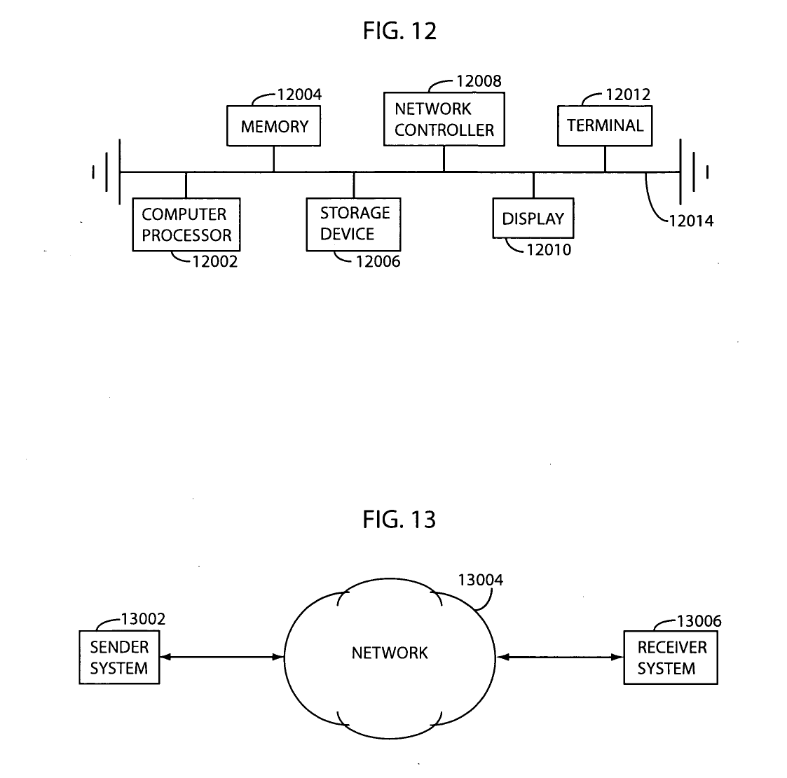

FIG. 12

FIG. 12 is a computer system hardware diagram depicting the computer components making up a sender system (13002) or a receiver system (13006).

All computer components communicate over an internal network (data bus) (12014). The computer processor (12002), memory (12004), storage device (12006), and network controller (12008) are required components for a sender system (13002) or a receiver system (13006). The display (12010) and the terminal (12012) are optional components for a sender system (13002) or a receiver system (13006).

FIG. 13

FIG. 13 is a block diagram depicting a sender system (13002) which is connected to a network (13004). A receiver system (13006) is connected to the network (13004). The network (13004) may be comprised of many sub-networks of multiple types. The network of (13004) may be able to carry a reliable data delivery protocol across the network (13004). The reliable data delivery protocol comprises a protocol that can guarantee: data delivery, data integrity, and data order preservation between the sender (13002) and the receiver (13006). For example: some embodiments may use a connection oriented protocol such as the Transmission Control Protocol (TCPv4/TCPv6) as the reliable data delivery protocol.

FIG. 14

FIG. 14 is a flowchart diagram of a sender data transformation module. The sub-process 14000 begins at operation (14002) and optionally accepts data from the read data (3010) operation. Data is then transformed by the transformation module (14004) by one or more transformation module methods.

Some embodiments use the encrypt data (14006) module method to encrypt data read by the sender system (13002) from the data source (1014).

Some embodiments use the deduplicate data module method (14008) to deduplicate (I.e. to eliminate duplicate data blocks) data read by the sender system (13002) from the data source (1014).

Some embodiments use the compress data module method (14010) to compress data read by the sender system (13002) from the data source (1014).

Some embodiments use the reformat data module method (14012) to reformat data read by the sender system (13002) from the data source (1014).

Some embodiments may not use the data transformation module (14004) at all but for illustrative purposes, the null (14014) data transformation module method is depicted.

Some embodiments may use any combination of the data transformation module methods.

Each transformation module method can be thought of as part of a pipeline where embodiments can optionally select the transformation data module methods to be used, and the order in which the transformation data module methods may be executed. A connector (14018) from the transformation module to the transformation data module methods is illustrated to demonstrate communication between the transformation module and an optionally selected set of transformation data module methods.

Once the transformation module (14004) has optionally transformed data read by the sender system (13002) from the data source (1014), the transformed data is made available to the process 3000 for continuing operations.

FIG. 15

FIG. 15 is a flowchart diagram of a receiver data transformation module.

The sub-process 15000 begins at operation (15002) and optionally accepts data from the LCL_BUFF (8032) or the SHARED_BUFF (8040) operation. Data is then transformed by the transformation module (15004) by one or more transformation module methods.

Some embodiments use the decrypt data (15006) module method to decrypt data stored in either the LCL_BUFF (8032) or the SHARED_BUFF (8040) of the receiver system (13006).

Some embodiments use the revert deduplicate data module method to deduplicate (I.e. to expand data from a deduplicated state to a non-deduplicated state) data stored in either the LCL_BUFF (8032) or the SHARED_BUFF (8040) of the receiver system (13006).

Some embodiments use the decompress data module method (15010) to decompress data stored in either the LCL_BUFF (8032) or the SHARED_BUFF (8040) of the receiver system (13006).

Some embodiments use the reformat data module method (15012) to reformat data stored in either the LCL_BUFF (8032) or the SHARED_BUFF (8040) of the receiver system (13006).

Some embodiments may not use the data transformation module (15004) at all but for illustrative purposes, the null (15014) data transformation module method is depicted.

Some embodiments may use any combination of the data transformation module methods.

Each transformation module method can be thought of as part of a pipeline where embodiments can optionally select the transformation data module methods to be used, and the order in which the transformation data module methods may be executed. A connector (15018) from the transformation module to the transformation data module methods is illustrated to demonstrate communication between the transformation module and an optionally selected set of transformation data module methods.

Once the transformation module (15004) has optionally transformed data stored in either the LCL_BUFF (8032) or the SHARED_BUFF (8040) of the receiver system (13006), the transformed data is made available to the process 8000 for continuing operations.

Embodiments of the parallel system for data transfer in an elastic latency network use reliable data delivery protocols for communication over a network between the sender system and the receiver system. By using multiple data transmission channels, the effective transfer rate of the system is vastly enhanced when transferring data over a network where the time delay (latency) of transmission is arbitrarily high.

The sender system is forced to wait in the data reader (3000) process for the sender network instances (4000) to finish transmitting all of the data in a global buffer and likewise, the receiver system is forced to wait in the receiver network instances (7000) for the data writer (8000) process to finish writing all data in a buffer. This creates the concept of a data round which enforces synchronization between the sender system and the receiver system without having to transmit or maintain any shared state information between the sender system and the receiver system. This synchronization: limits the amount of data lost if a network failure occurs during transmission, limits the performance impact of one data channel transmitting more slowly than the others, and limits the impact to the network load as the network naturally balances the bandwidth of each data channel against other data communication tasks transferred over the network.

The data round only allows a specific number of data blocks to be transmitted for each round where the number of data blocks is equal to the number of data channels established between the sender system and the receiver system. The size of the memory for buffering data blocks on the sender system and the receiver system is therefore deterministic and can be calculated by multiplying the data block size by the number of data channels established between the sender and the receiver.

For added efficiency, the illustrated sender embodiment uses atomic execution blocks, shared memory, and conditional signals to enable the sender system to read the next set of data round data blocks while the sender system is simultaneously transmitting the current set of data round data blocks in parallel to the receiver system. The illustrated receiver embodiment likewise uses atomic execution blocks, shared memory, and conditional signals to enable the receiver to receive the next set of data round data blocks in parallel while the receiver system is simultaneously writing the current set of data round data blocks. This method of simultaneously reading and transmitting—receiving and writing is similar to the double buffering methods used by graphics systems.

Since data is read from the data source sequentially, the data round concept forces synchronization between the sender system and the receiver system, and a reliable data delivery protocol is used for transmission of data over the network therefore the data target on the receiver system may be written to in the same sequential order as the data was read from the sender system data source. This enables the embodiments to read from and write to a multitude of storage sources and targets (e.g. files, directories, character devices, and block devices), other processes (e.g. through named pipes or regular command pipes), other network socket connections, or from data terminals. Most data sources and data targets encountered are readable and/or writable in a sequential linear order (as opposed to a random access order). For example: some embodiments may read directly from a tape drive, transmit data over the network, and write directly to a tape drive. As an additional example: some embodiments may read directly from a network socket, transmit data over the network, and write directly to a network socket thus creating a proxy transmission service between two systems external to the sender system and receiver system. As a final example: some embodiments may read directly from a network socket, transmit data over the network, and write directly to tape drive thus creating a proxy transmission service between a backup server and a tape drive.

The emergent performance characteristics of the embodiments provide a stable data transmission system where the transmission speed remains relatively uniform throughout the duration of the transmission. This steady transmission speed coupled with the sequential reading and writing of data enables the embodiments to be used for transmission of streaming data sources.

The embodiment(s) or portion(s) of embodiment(s) may be practiced by software implemented in the form of a computer readable storage medium tangibly embodying a program of instructions executable by a computer processor that, when executed, causes a computer to effect the embodiment(s) or portion(s) of embodiment(s). With respect to the term “computer”, such term should be construed broadly as encompassing all types of computers capable of performing the functions of the embodiment(s) or portion(s) of embodiment(s) e.g., a non-exhaustive list including: personal computers, server computers, mainframe computers, super computers, system on a chip (SoC) computers, FPGAs, ASICs, network switches and routers, storage switches and routers, optical computers, etc. Similarly, with respect to the term “computer readable storage medium”, such term should be construed broadly as encompassing all types of storage mediums readable by a computer e.g., a non-exhaustive list including: magnetic medium (hard disks, floppy disks, tape, etc.), optical medium (CD-ROMs, DVD-ROMs, etc.), magneto-optical medium, flash memory, RAM, ROM, PROM, EEPROM, capacitance based medium, etc.

Although the present inventive subject matter has been described with reference to a number of illustrative embodiments thereof, it should be understood that numerous other modifications, embodiments, and order of operations within illustrated embodiments can be devised by those skilled in the art that will fall within the spirit and scope of the principles of the present inventive subject matter. Additionally, alternative uses of the present inventive subject matter will also be apparent to those skilled in the art.

What is claimed is:

1) A method of transmitting data from a sender to a receiver over a network, comprising:
a. providing a network controller which is able to:
1. initiate network connections over a network,
2. accept network connections from a network,
3. transmit data over an established network connection,
4. receive data from an established network connection,
b. providing a memory which is able to store in said memory:
1. a data source information block,
2. a numerical value representative of the number of parallel streams,
3. a plurality of data blocks, associated data block sizes, and associated data block offsets equal to said numerical value representative of the number of parallel streams,
4. a metadata information block,
5. a data target information block,
6. a command channel preamble,
7. a numerical value of the reader block size,
8. a numerical value of the reader starting offset,
c. providing a transmission job information source which is able to make transmission job information available for reading,
d. reading transmission job information from said transmission job information source and storing in said memory:
1. the data source in said data source information block,
2. the data target in said data target information block,
3. the numerical value representative of the number of parallel streams,
4. the numerical value of the reader block size,
5. the numerical value of the reader starting offset,
e. providing said data source which is able to make data and metadata available for reading,
f. reading metadata information from said data source and storing said metadata information in said memory metadata information block,
g. directing said data source to seek sequentially to said reader starting offset,
h. storing in said memory a command channel preamble with values set to:
1. said metadata information,
2. said data target information,
3. said numerical value representative of the number of parallel streams,
4. said numerical value of the reader block size,
5. said numerical value of the reader starting offset,
i. directing said network controller to establish a command channel over said network from said sender to said receiver using a reliable data delivery protocol,
j. transmitting said command channel preamble over said command channel,
k. directing said network controller to establish a plurality of data channels equal to said numerical value representative of the number of parallel streams over said network from said sender to said receiver using a reliable data delivery protocol,
l. reading sequentially from said data source a plurality of data blocks where:
1. the size of each data block does not exceed said numerical value of said reader block size,
2. the number of data blocks read does not exceed said numerical value representative of said number of parallel streams,
3. the data block size and the data block offset of each of said data blocks are associated with each of said data block,
m. storing each of said plurality of said data blocks, said associated data block sizes, and said associated data block offsets in said memory,
n. assigning each one of said plurality of data blocks, associated data block sizes, and associated data block offsets to a data channel within said plurality of data channels,
o. transmitting in parallel said assigned data block, associated data block size, and associated data block offset over said plurality of data channels,
p. repeating steps l through o until data is no longer readable from said data source,
q. transmitting a command over said command channel notifying said receiver that said data transmission is complete,
whereby said sender data source is read sequentially into said plurality of data blocks which are stored in deterministically sized said memory and then transmitted in parallel over said network using said reliable data delivery protocol in a manner allowing said receiver to receive in parallel said data and store said data to a deterministically sized memory having the same size as said sender memory and where said receiver writes to a data target in the same sequential order as said data was originally read by said sender data source.

2) The method of claim 1 wherein said data source is one of:
a. a network socket,
b. a named pipe,
c. a regular command pipe reading from standard input,
d. a file,
e. a directory containing a plurality of files and/or additional directories,
f. a block device,
g. a character device,
h. a data terminal device operative by a human.

3) The method of claim 1 wherein said data transmission job information source is one of:
a. a network socket,
b. a named pipe,
c. a regular command pipe reading from standard input,
d. a file,
e. a data terminal device operative by a human.

4) The method of claim 1 further providing a display operatively connected to said memory which is able to display human readable information indicating:
a. the progress of said data transmission,
b. error state information of said data transmission,
c. completion state information of said data transmission.

5) The method of claim 1 further providing a data transformation means able to transform data as said data is read from said data source, said transformation means including one or more of:
a. compression using a compression means of known type,
b. encryption using an encryption means of known type,
c. deduplication using a deduplication means of known type,
d. data reformatting from a known data format to another known data format,
wherein said command channel preamble additionally stores a data transformation information block.

6) The method of claim 1 wherein said command channel preamble also stores:
a. a channel type identifier value indicating the channel type is a command channel,
b. a command channel identification value,
enabling said sender to transmit multiple instances of data transmissions simultaneously to said receiver or plurality of receivers.

7) The method of claim 1 further:
a. providing a memory which is able to store in said memory a plurality of data channel preambles,
b. storing in said memory a plurality of said data channel preambles with each of said data channel preambles having values set to:
1. a channel type identifier value indicating the channel type is a data channel,
2. the command channel identification value associating said data channel with said command channel,
3. a data channel identification value unique to each of said data channels in said plurality of data channels,
c. assigning each one of said plurality of data channel preambles to a data channel within said plurality of data channels,
d. transmitting each one of said associated data channel preambles over each one of said associated data channels immediately following establishment of said plurality of data channels by said network controller.

8) The method of claim 1 wherein said reliable data delivery protocol can be a connection oriented protocol of known type.

9) The method of claim 1 wherein said reliable data delivery protocol can be a protocol of known type guaranteeing:
a. data delivery from said sender to said receiver,
b. data integrity from said sender to said receiver,
c. data order preservation from said sender to said receiver.

10) The method of claim 1 further:
a. providing a memory which is able to store in said memory a checkpoint offset value equal to an associated data block offset plus an associated data block size where said data block has the largest associated data block offset and is confirmed to have been received by said receiver,
b. storing said checkpoint offset value in said memory,
c. setting said reader starting offset to said checkpoint offset value,
d. restarting said data transmission using said reader starting offset to continue said data transmission.

11) The method of claim 1 wherein said sender can perform identical simultaneous data transmissions to a plurality of receivers by replicating steps i through q of claim 1 for each of said plurality of receivers.

12) A method of receiving data transmitted by a sender to a receiver over a network, comprising:
a. providing a network controller which is able to:
1. accept network connections from a network,
2. initiate network connections over a network,
3. receive data from an established network connection,
4. transmit data over an established network connection,
b. providing a memory which is able to store in said memory:
1. a data target information block,
2. a numerical value representative of the number of parallel streams,
3. a plurality of data blocks, associated data block sizes, and associated data block offsets equal to said numerical value representative of the number of parallel streams,
4. a metadata information block,
5. a command channel preamble,
6. a numerical value of the writer block size,
7. a numerical value of the writer starting offset,
c. directing said network controller to wait for and accept upon receipt a command channel established over said network from said sender to said receiver using a reliable data delivery protocol,
d. receiving a command channel preamble from said command channel,
e. storing in said memory said command channel preamble with values set by said sender to:
1. a metadata information block,
2. a data target information block,
3. a numerical value representative of the number of parallel streams,
4. a numerical value representative of the writer block size,
5. a numerical value representative of the writer starting offset,
f. storing in said memory metadata information block said metadata information block from said command channel preamble,
g. storing in said memory from said command channel preamble:
1. said data target information,
2. said numerical value representative of the number of parallel streams,
3. said numerical value representative of the writer block size,
4. said numerical value representative of the writer starting offset,
h. providing said data target which is able to accept data and metadata for writing,
i. writing said metadata information stored in said memory metadata information block to said data target,
j. directing said data target to seek sequentially to said writer starting offset,
k. directing said network controller to wait for and accept upon receipt a plurality of data channels equal to said numerical value representative of the number of parallel streams established over said network from said sender to said receiver using a reliable data delivery protocol,
l. receiving in parallel from said plurality of data channels where each of said data channels will:
1. receive a data block size associated with said data block,
2. receive a data block offset associated with said data block,
3. receive a data block having a size equal to said associated data block size,
m. storing said plurality of data blocks, associated data block sizes, and associated data block offsets in said memory,
n. writing sequentially to said data target said plurality of data blocks where said data blocks are written in sequential data block offset order,
o. repeating steps I through n until said receiver receives a command from said command channel notifying said receiver that said data transmission is complete,
whereby said receiver receives in parallel from said network using said reliable data delivery protocol said plurality of data blocks which are stored in deterministically sized said memory and then written sequentially based on said data block offsets to said data target.

13) The method of claim 12 wherein said data target is one of:
a. a network socket,
b. a named pipe,
c. a regular command pipe writing to standard output,
d. a file,
e. a directory,
f. a block device,
g. a character device,
h. a data terminal device operative by a human.

14) The method of claim 12 further providing a display operatively connected to said memory which is able to display human readable information indicating:
a. the progress of receiving said data transmission,
b. error state information of receiving said data transmission,
c. completion state information of receiving said data transmission.

15) The method of claim 12 further providing a data transformation means able to transform data as said data is written to said data target, said transformation means including one or more of:
a. decompression using a decompression means of known type,
b. decryption using a decryption means of known type,
c. reversion of deduplication using a reversion of deduplication means of known type,
d. data reformatting from a known data format to another known data format,
wherein said command channel preamble additionally stores a data transformation information block.

16) The method of claim 12 wherein said command channel preamble also stores:
a. a channel type identifier value indicating the channel type is a command channel,
b. a command channel identification value,
enabling said receiver to receive multiple instances of data transmissions simultaneously from said sender.

17) The method of claim 12 further:
a. providing a memory which is able to store in said memory a plurality of data channel preambles,
b. receiving each one of said plurality of data channel preambles from each one of said plurality of data channels immediately following acceptance of each one of said plurality of data channels by said network controller,
c. storing in said memory said plurality of said data channel preambles with each of said data channel preambles having values set to:
1. a channel type identifier value indicating the channel type is a data channel,
2. the command channel identification value associating said data channel with said command channel,
3. a data channel identification value unique to each of said data channels in said plurality of data channels.

18) The method of claim 12 wherein said reliable data delivery protocol can be a connection oriented protocol of known type.

19) The method of claim 12 wherein said reliable data delivery protocol can be a protocol of known type guaranteeing:
a. data delivery from said sender to said receiver,
b. data integrity from said sender to said receiver,
c. data order preservation from said sender to said receiver.

20) The method of claim 12 further:
a. providing a memory which is able to store in said memory a checkpoint offset value equal to an associated data block offset plus an associated data block size where said data block has the largest associated data block offset and is confirmed to have been received by said receiver,
b. storing said checkpoint offset value in said memory,
c. setting said writer starting offset to said checkpoint offset value,
d. transmitting a command over said command channel notifying said sender to restart said data transmission to continue said data transmission.

21) A machine for transmitting data from a sender to a receiver over a network, comprising:
a. a network controller which is able to:
1. initiate network connections over a network,
2. accept network connections from a network,
3. transmit data over an established network connection,
4. receive data from an established network connection,
b. a memory which is able to store in said memory:
1. a data source information block,
2. a numerical value representative of the number of parallel streams,
3. a plurality of data blocks, associated data block sizes, and associated data block offsets equal to said numerical value representative of the number of parallel streams,
4. a metadata information block,
5. a data target information block,
6. a command channel preamble,
7. a numerical value of the reader block size,
8. a numerical value of the reader starting offset,
c. a transmission job information source which is able to make transmission job information available for reading,
d. cause the reading of transmission job information from said transmission job information source and storing in said memory:
1. the data source in said data source information block,
2. the data target in said data target information block,
3. the numerical value representative of the number of parallel streams,
4. the numerical value of the reader block size,
5. the numerical value of the reader starting offset,
e. a said data source which is able to make data and metadata available for reading,
f. cause the reading of metadata information from said data source and storing said metadata information in said memory metadata information block,
g. cause said data source to seek sequentially to said reader starting offset,
h. cause the storing in said memory of a command channel preamble with values set to:
1. said metadata information,
2. said data target information,
3. said numerical value representative of the number of parallel streams,
4. said numerical value of the reader block size,
5. said numerical value of the reader starting offset,
i. cause said network controller to establish a command channel over said network from said sender to said receiver using a reliable data delivery protocol,
j. cause transmission of said command channel preamble over said command channel,
k. cause said network controller to establish a plurality of data channels equal to said numerical value representative of the number of parallel streams over said network from said sender to said receiver using a reliable data delivery protocol,
l. cause the sequential reading from said data source a plurality of data blocks where:
1. the size of each data block does not exceed said numerical value of said reader block size,
2. the number of data blocks read does not exceed said numerical value representative of said number of parallel streams,
3. the data block size and the data block offset of each of said data blocks are associated with each of said data block,
m. cause the storage of each of said plurality of said data blocks, said associated data block sizes, and said associated data block offsets in said memory,
n. cause the assignment of each one of said plurality of data blocks, associated data block sizes, and associated data block offsets to a data channel within said plurality of data channels,
o. cause the transmission in parallel of said assigned data block, associated data block size, and associated data block offset over said plurality of data channels,
p. cause the repetition of steps I through o until data is no longer readable from said data source,
q. cause the transmission of a command over said command channel notifying said receiver that said data transmission is complete,
whereby said sender data source is read sequentially into said plurality of data blocks which are stored in deterministically sized said memory and then transmitted in parallel over said network using said reliable data delivery protocol in a manner allowing said receiver to receive in parallel said data and store said data to a deterministically sized memory having the same size as said sender memory and where said receiver writes to a data target in the same sequential order as said data was originally read by said sender data source.

22) The machine of claim 21 wherein said data source is one of:
a. a network socket,
b. a named pipe,
c. a regular command pipe reading from standard input,
d. a file,
e. a directory containing a plurality of files and/or additional directories,
f. a block device,
g. a character device,
h. a data terminal device operative by a human.

23) The machine of claim 21 wherein said data transmission job information source is one of:
a. a network socket,
b. a named pipe,
c. a regular command pipe reading from standard input,
d. a file,
e. a data terminal device.

24) The machine of claim 21 further comprising a display operatively connected to said memory which is able to display human readable information indicating:
a. the progress of said data transmission,
b. error state information of said data transmission,
c. completion state information of said data transmission.

25) The machine of claim 21 further comprising a data transformation means causing data to be transformed as said data is read from said data source, said transformation means including one or a more of:
a. compression using a compression means of known type,
b. encryption using an encryption means of known type,
c. deduplication using a deduplication means of known type,
d. data reformatting from a known data format to another known data format,
wherein said command channel preamble additionally comprises a data transformation information block.

26) The machine of claim 21 wherein said command channel preamble additionally comprises:
a. a channel type identifier value indicating the channel type is a command channel,
b. a command channel identification value,
enabling said sender system to cause the transmission of multiple instances of data transmissions simultaneously to said receiver or plurality of receivers.

27) The machine of claim 21 further:
a. comprising a memory which is able to store in said memory a plurality of data channel preambles,
b. causes a plurality of said data channel preambles to be stored in said memory with each of said data channel preambles having values set to:
1. a channel type identifier value indicating the channel type is a data channel,
2. the command channel identification value associating said data channel with said command channel,
3. a data channel identification value unique to each of said data channels in said plurality of data channels,
c. causes the assignment of each one of said plurality of data channel preambles to a data channel within said plurality of data channels,
d. causes the transmission of each one of said associated data channel preambles over each one of said associated data channels immediately following establishment of said plurality of data channels by said network controller.

28) The machine of claim 21 wherein said reliable data delivery protocol can be a connection oriented protocol of known type.

29) The machine of claim 21 wherein said reliable data delivery protocol can be a protocol of known type guaranteeing:
a. data delivery from said sender to said receiver,
b. data integrity from said sender to said receiver,
c. data order preservation from said sender to said receiver.

30) The machine of claim 21 further:
a. comprising a memory which is able to store in said memory a checkpoint offset value equal to an associated data block offset plus an associated data block size where said data block has the largest associated data block offset and is confirmed to have been received by said receiver,
b. causes said checkpoint offset value to be stored in said memory,
c. causes said reader starting offset to be set in said memory to said checkpoint offset value,
d. causes said data transmission to restart using said reader starting offset to continue said data transmission.

31) The machine of claim 21 wherein said sender system can be caused to perform identical simultaneous data transmissions to a plurality of receivers by replicating steps i through q of claim 21 for each of said plurality of receiver systems.

32) A machine for receiving data transmitted by a sender to a receiver over a network, comprising:
a. a network controller which is able to:
1. accept network connections from a network,
2. initiate network connections over a network,
3. receive data from an established network connection,
4. transmit data over an established network connection,
b. a memory which is able to store in said memory:
1. a data target information block,
2. a numerical value representative of the number of parallel streams,
3. a plurality of data blocks, associated data block sizes, and associated data block offsets equal to said numerical value representative of the number of parallel streams,
4. a metadata information block,
5. a command channel preamble,
6. a numerical value of the writer block size,
7. a numerical value of the writer starting offset,
c. cause said network controller to wait for and accept upon receipt a command channel established over said network from said sender to said receiver using a reliable data delivery protocol,
d. cause the receiving of a command channel preamble from said command channel,
e. cause the storing in said memory of said command channel preamble with values set by said sender to:
1. a metadata information block,
2. a data target information block,
3. a numerical value representative of the number of parallel streams,
4. a numerical value representative of the writer block size,
5. a numerical value representative of the writer starting offset,
f. cause the storing in said memory metadata information block of said metadata information block from said command channel preamble,
g. cause the storing in said memory from said command channel preamble:
1. said data target information,
2. said numerical value representative of the number of parallel streams,
3. said numerical value representative of the writer block size,
4. said numerical value representative of the writer starting offset,
h. a said data target which is able to accept data and metadata for writing,
i. cause the writing of said metadata information stored in said memory metadata information block to said data target,
j. cause said data target to seek sequentially to said writer starting offset,
k. cause said network controller to wait for and accept upon receipt a plurality of data channels equal to said numerical value representative of the number of parallel streams established over said network from said sender to said receiver using a reliable data delivery protocol,
l. cause the receiving in parallel from said plurality of data channels where each of said data channels will:
1. receive a data block size associated with said data block,
2. receive a data block offset associated with said data block,
3. receive a data block having a size equal to said associated data block size,
m. cause the storing of each of said plurality of said data blocks, associated said data block sizes, and associated said data block offsets in said memory,
n. cause the writing sequentially to said data target of said plurality of data blocks where said data blocks are written in sequential data block offset order,
o. cause the repetition of steps I through n until said receiver receives a command from said command channel notifying said receiver that said data transmission is complete,
whereby said receiver receives in parallel from said network using said reliable data delivery protocol said plurality of data blocks which are stored in deterministically sized said memory and then written sequentially based on said data block offsets to said data target.

33) The machine of claim 32 wherein said data target is one of:
a. a network socket,
b. a named pipe,
c. a regular command pipe writing to standard output,
d. a file,
e. a directory,
f. a block device,
g. a character device,
h. a data terminal device operative by a human.

34) The machine of claim 32 further comprising a display operatively connected to said memory which is able to display human readable information indicating:
a. the progress of receiving said data transmission,
b. error state information of receiving said data transmission,
c. completion state information of receiving said data transmission.

35) The machine of claim 32 further comprising a data transformation means causing data to be transformed as said data is written to said data target, said transformation means including one or a more of:
a. decompression using a decompression means of known type,
b. decryption using a decryption means of known type,
c. reversion of deduplication using a reversion of deduplication means of known type,
d. data reformatting from a known data format to another known data format, wherein said command channel preamble additionally comprises a data transformation information block.

36) The machine of claim 32 wherein said command channel preamble additionally comprises:
a. a channel type identifier value indicating the channel type is a command channel,
b. a command channel identification value, enabling said receiver system to cause the simultaneous receipt of multiple instances of data transmissions from said sender.

37) The machine of claim 32 further:
a. comprising a memory which is able to store in said memory a plurality of data channel preambles,
b. causes the receipt of each one of said plurality of data channel preambles from each one of said plurality of data channels immediately following acceptance of each one of said plurality of data channels by said network controller,
c. causes a plurality of said data channel preambles to be stored in said memory with each of said data channel preambles having values set to:
1. a channel type identifier value indicating the channel type is a data channel,
2. the command channel identification value associating said data channel with said command channel,
3. a data channel identification value unique to each of said data channels in said plurality of data channels.

38) The machine of claim 32 wherein said reliable data delivery protocol can be a connection oriented protocol of known type.

39) The machine of claim 32 wherein said reliable data delivery protocol can be a protocol of known type guaranteeing:
a. data delivery from said sender to said receiver,
b. data integrity from said sender to said receiver,
c. data order preservation from said sender to said receiver.

40) The machine of claim 32 further:
a. comprising a memory which is able to store in said memory a checkpoint offset value equal to an associated data block offset plus an associated data block size where said data block has the largest associated data block offset and is confirmed to have been received by said receiver,
b. causes said checkpoint offset value to be stored in said memory,
c. causes said writer starting offset to be set in said memory to said checkpoint offset value,
d. causes the transmission of a command over said command channel notifying said sender to restart said data transmission to continue said data transmission.

41) A network transmission computer program product comprising:
a. a computer processor having:
1. a means to direct a network controller to:
aa. initiate network connections over a network,
bb. accept network connections from a network,
cc. transmit data over an established network connection,
dd. receive data from an established network connection,
2. a means to direct a memory to:
aa. store data in said memory,
bb. load data from said memory,
3. a means to read transmission job information from a transmission job information source,
4. a means to direct a data source to:
aa. read metadata information,
bb. read data blocks,
cc. seek to a starting reader offset location,
b. a sender system having a computer readable storage medium tangibly embodying a program of instructions executable by a computer processor:
c. said program arranged to cause said computer processor to read said transmission job information from said transmission job information source,
d. said program then arranged to cause said computer processor to store to said memory said data transmission job information comprising:
1. the data source,
2. the data target,
3. the numerical value representative of the number of parallel streams,
4. the numerical value of the reader block size,
5. the numerical value of the reader starting offset,
e. said program then arranged to cause said computer processor to read metadata information from said data source and to store said metadata information in said memory,
f. said program then arranged to cause said computer processor to seek to said reader starting offset on said data source,
g. said program then arranged to cause said computer processor to store to said memory a command channel preamble comprising:
1. said metadata information,
2. said data target information,
3. said numerical value representative of the number of parallel streams,
4. said numerical value of the reader block size,
5. said numerical value of the reader starting offset,
h. said program then arranged to cause said computer processor to direct said network controller to establish a command channel over said network from said sender system to a receiver system using a reliable data delivery protocol,
i. said program then arranged to cause said computer processor to transmit said command channel preamble over said command channel,
j. said program then arranged to cause said computer processor to direct said network controller to establish a plurality of data channels equal to said numerical value representative of the number of parallel streams over said network from said sender system to said receiver system using a reliable data delivery protocol,
k. said program then arranged to cause said computer processor to read sequentially from said data source a plurality of data blocks where:
1. the size of each data block does not exceed said numerical value of said receiver block size,
2. the number of data blocks read does not exceed said numerical value of said number of parallel streams,
3. the data block size and the data block offset of each of said data blocks are associated with each of said data block,
l. said program then arranged to cause said computer processor to store to said memory each of said plurality of said data blocks, said associated data block sizes, and said associated data block offsets,
m. said program then arranged to cause said computer processor to assign to a data channel within said plurality of data channels a data block, associated data block size, and associated data bock offset from said plurality of data blocks, said associated data block sizes, and said associated data block offsets,
n. said program then arranged to cause said computer processor to transmit in parallel over said plurality of data channels said assigned data block, associated data block size, and associated data block offset,
o. said program then arranged to cause said computer processor to repeat steps k through n until data is no longer readable by said computer processor from said data source,
p. said program then arranged to cause said computer processor to transmit a command notifying said receiver that said data transmission is complete over said command channel.

42) The product of claim 41 wherein said data source is one of:
a. a network socket,
b. a named pipe,
c. a regular command pipe reading from standard input,
d. a file,
e. a directory containing a plurality of files and/or additional directories,
f. a block device,
g. a character device,
h. a data terminal device operative by a human.

43) The product of claim 41 wherein said data transmission job information source is one of:
a. a network socket,
b. a named pipe,
c. a regular command pipe reading from standard input,
d. a file,
e. a data terminal device operative by a human.

44) The product of claim 41 wherein said computer processor further having a means to direct a display operatively connected to said memory which is able to display human readable information wherein said computer program then arranged to cause said computer processor to display information on said display indicating:
a. the progress of said data transmission,
b. error state information of said data transmission,
c. completion state information of said data transmission.

45) The product of claim 41 wherein said computer processor further having a means to transform data as said data is read from said data source, wherein said computer program then arranged to cause said computer processor to transform data using said transformation means capable of one or more of:
a. compressing said data using a compression means of known type,
b. encrypting said data using an encryption means of known type,
c. deduplicating said data using a deduplication means of known type,
d. reformatting said data from a known data format to another known data format,
wherein said computer program then arranged to cause said computer processor to additionally store a data transformation information block in said command channel preamble.

46) The product of claim 41 wherein said computer program then arranged to cause said computer processor to additionally store in said command channel preamble:
a. a channel type identifier value indicating the channel type is a command channel,
b. a command channel identification value,
enabling said computer program then arranged to cause said computer processor to transmit multiple instances of data transmissions simultaneously to said receiver or plurality of receivers.

47) The product of claim 41 wherein said computer program then arranged to:
a. cause said computer processor to store to said memory a plurality of data channel preambles with each of said data channel preambles having values set to:
1. a channel type identifier value indicating the channel type is a data channel,
2. the command channel identification value associating said data channel with said command channel,
3. a data channel identification value unique to each of said data channels in said plurality of data channels,
b. cause said computer processor to assign each one of said plurality of data channel preambles to a data channel within said plurality of data channels,
c. cause said computer processor to direct said network controller to transmit each one of said associated data channel preambles over each one of said associated data channels immediately following establishment of said plurality of data channels by said network controller.

48) The product of claim 41 wherein said reliable data delivery protocol can be a connection oriented protocol of known type.

49) The product of claim 41 wherein said reliable data delivery protocol can be a protocol of known type guaranteeing:
a. data delivery from said sender to said receiver,
b. data integrity from said sender to said receiver,
c. data order preservation from said sender to said receiver.

50) The product of claim 41 wherein said computer program then arranged to:
a. cause said computer processor to store to said memory a checkpoint offset value equal to an associated data block offset plus an associated data block size where said data block has the largest associated data block offset and is confirmed to have been received by said receiver,
b. cause said computer processor to set said reader starting offset to said checkpoint offset value,
c. cause said computer processor to restart said data transmission using said reader starting offset to continue said data transmission.

51) The product of claim 41 wherein said computer program then arranged to cause said computer processor to perform identical simultaneous data transmissions to a plurality of receivers by replicating steps h through p of claim 41 for each of said plurality of receivers.

52) A network receiver computer program product comprising:
a. a computer processor having:
1. a means to direct a network controller to:
aa. accept network connections from a network,
bb. initiate network connections over a network,
cc. receive data from an established network connection,
dd. transmit data over an established network connection,
2. a means to direct a memory to:
aa. store data in said memory,
bb. load data from said memory,
3. a means to direct a data target to:
aa. write metadata information,
bb. write data blocks,
cc. seek to a starting writer offset location,
b. a receiver system having a computer readable storage medium tangibly embodying a program of instructions executable by a computer processor:
c. said program arranged to cause said computer processor to direct said network controller to wait for and accept upon receipt a command channel established over said network from a sender to said receiver using a reliable data delivery protocol,
d. said program then arranged to cause said computer processor to receive a command channel preamble from said command channel,
e. said program then arranged to cause said computer processor to store to said memory said command channel preamble comprising:
1. a metadata information block,
2. a data target information block,
3. a numerical value representative of the number of parallel streams,
4. a numerical value representative of the writer block size,
5. a numerical value representative of the writer starting offset,
f. said program then arranged to cause said computer processor to store to said memory from said command channel preamble said metadata information,
g. said program then arranged to cause said computer processor to store to said memory from said command channel preamble:
1. said data target information,
2. said numerical value representative of the number of parallel streams,
3. said numerical value representative of the writer block size,
4. said numerical value representative of the writer starting offset,
h. said program then arranged to cause said computer processor to write metadata information stored in said memory to said data target,
i. said program then arranged to cause said computer processor to seek to said writer starting offset on said data target,
j. said program then arranged to cause said computer processor to direct said network controller to wait for and accept upon receipt a plurality of data channels equal to said numerical value representative of the number of parallel streams established over said network from said sender to said receiver using a reliable data delivery protocol,
k. said program then arranged to cause said computer processor to receive in parallel from said plurality of data channels where each of said data channels will:
1. receive a data block size associated with said data block,
2. receive a data block offset associated with said data block,
3. receive a data block having a size equal to said associated data block size,
l. said program then arranged to cause said computer processor to store in said memory said received plurality of data blocks, associated data block sizes, and associated data block offsets,
m. said program then arranged to cause said computer processor to write sequentially to said data target said plurality of data blocks where said data blocks are written in sequential data block offset order,
n. said program then arranged to cause said computer processor to repeat steps k through m until a command is received from said command channel notifying said receiver that said data transmission is complete.

53) The product of claim 52 wherein said data target is one of:
a. a network socket,
b. a named pipe,
c. a regular command pipe writing to standard output,
d. a file,
e. a directory,
f. a block device,
g. a character device,
h. a data terminal device operative by a human.

54) The product of claim 52 wherein said computer processor further having a means to direct a display operatively connected to said memory which is able to display human readable information wherein said computer program then arranged to cause said computer processor to display information on said display indicating:
a. the progress of receiving said data transmission,
b. error state information of receiving said data transmission,
c. completion state information of receiving said data transmission.

55) The product of claim 52 wherein said computer processor further having a means to transform data as said data is written to said data target, wherein said computer program then arranged to cause said computer processor to transform data using said transformation means capable of one or more of:
a. decompressing said data using a decompression means of known type,
b. decrypting said data using an decryption means of known type,
c. reverting deduplication of said data using a reversion of deduplication means of known type,
d. reformatting said data from a known data format to another known data format,
wherein said computer program then arranged to cause said computer processor to additionally store a data transformation information block in said command channel preamble.

56) The product of claim 52 wherein said computer program then arranged to cause said computer processor to additionally store in said command channel preamble:
a. a channel type identifier value indicating the channel type is a command channel,
b. a command channel identification value,
enabling said computer program then arranged to cause said computer processor to receive multiple instances of data transmissions simultaneously from said sender.

57) The product of claim 52 wherein said computer program then arranged to:
a. cause said computer processor to direct said network controller to receive each one of said plurality of data channel preambles from each one of said plurality of data channels immediately following acceptance of each one of said plurality of data channels by said network controller,
b. cause said computer processor to store to said memory said plurality of data channel preambles with each of said data channel preambles having values set to:
1. a channel type identifier value indicating the channel type is a data channel,
2. the command channel identification value associating said data channel with said command channel,
3. a data channel identification value unique to each of said data channels in said plurality of data channels.

58) The product of claim 52 wherein said reliable data delivery protocol can be a connection oriented protocol of known type.

59) The product of claim 52 wherein said reliable data delivery protocol can be a protocol of known type guaranteeing:
a. data delivery from said sender to said receiver,
b. data integrity from said sender to said receiver,
c. data order preservation from said sender to said receiver.

60) The product of claim 52 wherein said computer program then arranged to:
a. cause said computer processor to store to said memory a checkpoint offset value equal to an associated data block offset plus an associated data block size where said data block has the largest associated data block offset and is confirmed to have been received by said receiver,
b. cause said computer processor to set said writer starting offset to said checkpoint offset value,
c. cause said computer processor to transmit a command over said command channel notifying said sender to restart said data transmission to continue said transmission.
